(19) United States
(12) Patent Application Publication
(10) Pub. No.: US 2003/0062422 A1
(43) Pub. Date: Apr. 3, 2003

(54) System and method for encoded spatio-spectral information processing

(76) Inventors: William G. Fateley, Manhattan, KS (US); Ronald R. Coifman, North Haven, CT (US); Frank Geshwind, Madison, CT (US); Richard A. DeVerse, Kailue-kona, HI (US)

Correspondence Address: PENNIE AND EDMONDS, 1155 AVENUE OF THE AMERICAS, NEW YORK, NY, 100362711

(21) Appl. No.: 10/238,408

(22) Filed: Sep. 9, 2002

Related U.S. Application Data
(60) Provisional application No. 60/318,522, filed on Sep. 10, 2001.

(51) Int. Cl. G06K 19/06

(52) U.S. Cl. 235/494

(57) ABSTRACT

Systems and methods for encoded spatio-spectral information processing are disclosed. In a specific aspect, the invention involves applying or embedding of digital information in the spectral profile of materials, such as inks and paints, to provide the functionality of bar codes or labels, and reading such information from objects. Recording of digital information is enabled onto or into physical media with or without the use of printed symbols, by spraying, mixing or enabling a specific chemical changes resulting in digital information being encoded onto or into carrying materials. Because the information is encoded in the spectral signatures of compositions of materials, the precise location, shape, orientation and arrangement of marks is generally not used in the process of decoding. Various applications are disclosed.

This application claims the priority of provisional application No. 60/318,522, filed Sep. 10, 2001, which is incorporated herein by reference.

### FIELD OF THE INVENTION

The present invention relates generally to signal processing, and more particularly to devices and methods for use in spectroscopy, imaging, spatial and spectral modulation filtering, controllable radiation source design and related signal processing. In another aspect, the invention relates to methods and systems for embedding, writing, and reading digital information and tags in the spectral profile of ink, paint or other materials, in order to provide the functionality of bar codes and digital tags.

### BACKGROUND OF THE INVENTION

Imagers employ either a two-dimensional (2D) multichannel detector array or a single element detector. Imagers using a 2D detector array measure the intensity distribution of all spatial resolution elements simultaneously during the entire period of data acquisition. Imagers using a single detector require that the individual spatial resolution elements be measured consecutively via a raster scan so that each one is observed for a small fraction of the period of data acquisition. Prior art imagers using a plurality of detectors at the image plane can exhibit serious signal-to-noise ratio problems. Prior art imagers using a single element detector can exhibit more serious signal-to-noise ratio problems. Signal-to-noise ratio problems limit the utility of imagers applied to chemical imaging applications where subtle differences between a sample's constituents become important.

Spectrometers are commonly used to analyze the chemical composition of samples by determining the absorption or attenuation of certain wavelengths of electromagnetic radiation by the sample or samples. Because it is typically necessary to analyze the absorption characteristics of more than one wavelength of radiation to identify a compound, and because each wavelength must be separately detected to distinguish the wavelengths, prior art spectrometers utilize a plurality of detectors, have a moving grating, or use a set of filter elements. However, the use of a plurality of detectors or the use of a macro moving grating has signal-to-noise limitations. The signal-to-noise ratio largely dictates the ability of the spectrometer to analyze with accuracy all of the constituents of a sample, especially when some of the constituents of the sample account for an extremely small proportion of the sample. There is, therefore, a need for imagers and spectrometers with improved signal-to-noise ratios.

Prior art variable band pass filter spectrometers, variable band reject filter spectrometers, variable multiple band pass filter spectrometers or variable multiple band reject filter spectrometers typically employ a multitude of filters that require macro moving parts or other physical manipulation in order to switch between individual filter elements or sets of filter elements for each measurement. Each filter element employed can be very expensive, difficult to manufacture and all are permanently set at the time of manufacture in the wavelengths (bands) of radiation that they pass or reject. Physical human handling of the filter elements can damage them and it is time consuming to change filter elements. There is, therefore, a need for variable band pass filter spectrometers, variable band reject filter spectrometers, variable multiple band pass filter spectrometers or variable multiple band reject filter spectrometers without a requirement for discrete (individual) filter elements that have permanently set band pass or band reject properties. There is also a need for variable band pass filter spectrometers, variable band reject filter spectrometers, variable multiple band pass filter spectrometers or variable multiple band reject filter spectrometers to be able to change the filters corresponding to the bands of radiation that are passed or rejected rapidly, without macro moving parts and without human interaction.

In several practical applications it is required that an object be irradiated with radiation having particularly shaped spectrum. In the simplest case when only a few spectrum lines (or bands) are necessary, one can use a combination of corresponding sources, each centered near a required spectrum band. Clearly, however, this approach does not work in a more general case, and therefore it is desirable to have a controllable radiation source capable of providing arbitrary spectrum shapes and intensities. Several types of prior art devices are known that are capable of providing controllable radiation. Earlier prior art devices primarily relied upon various “masking” techniques, such as electronically alterable masks interposed in the optical pathway between a light source and a detector. More recent prior art devices use a combination of two or more light-emitting diodes (LEDs) as radiation sources. In such cases, an array of LEDs or light-emitting lasers is configured for activation using a particular encoding pattern, and can be used as a controllable light source. A disadvantage of these systems is that they rely on an array of different LED elements (or lasers), each operating in a different, relatively narrow spectrum band. In addition, there are technological problems associated with having an array of discrete radiation elements with different characteristics. Accordingly, there is a need for a controllable radiation source, where virtually arbitrary spectrum shape and characteristics can be designed, and where disadvantages associated with the prior art are obviated. Further, it is desirable not only to shape the spectrum of the radiation source, but also encode its components differently, which feature can be used to readily perform several signal processing functions useful in a number of practical applications. The phrase “a spectrum shape” in this disclosure refers not to a mathematical abstraction but rather to configurable spectrum shapes having range(s) and resolution necessarily limited by practical considerations.

In addition to the signal-to-noise issues discussed above, one can consider the tradeoff between signal-to-noise and, for example, one or more of the following resources: system cost, time to measure a scene, and inter-pixel calibration. Thus, in certain prior art systems, a single sensor system may cost less to produce, but will take longer to fully measure an object under study. In prior art multi-sensor systems, one often encounters a problem in which the different sensor elements have different response characteristics, and it is necessary to add components to the system to calibrate for this. It is desirable to have a system with which one gains the lower-cost, better signal-to-noise, and automatic inter-pixel calibration advantages of a single-sensor system, while not suffering all of the time loss usually associated with using single sensors.

Some of the problems identified above have been addressed in U.S. Pat. Nos. 6,046,808; 6,128,078 and 6,392,748 to the inventors of this application, which are hereby incorporated by reference.

Yet another problem in the prior art is associated with encoding of information in materials. The idea of using color or more generally spectral bands to discriminate and identify objects is known, for example in the color coding of wires, pills, signs, as well as in the tags used in gene arrays. But the problem with such approaches is that encoding information on the surface of an object is done by printing symbols, applying bar codes and other means that rely on: (1) generally smooth surface to permit printing thereon; and (2) for proper interpretation the prior art required symbols (such as letters, or bar codes) to be applied to an object under fairly rigid rules requiring, for example, specific positions on the object, orientations and shape of the symbols.

### SUMMARY OF THE INVENTION

In one aspect, the present invention solves the above-described problems and provides a distinct advance in the art by providing an imager or spectrometer that is less sensitive to ambient noise and that can effectively operate even when used in environments with a high level of ambient radiation. The invention further advances the art of variable band pass filter spectrometers, variable band reject filter spectrometers, variable multiple band pass filter spectrometers or variable multiple band reject filter spectrometers by providing a variable band pass filter spectrometer, variable band reject filter spectrometer, variable multiple band pass filter spectrometer or variable multiple band reject filter spectrometer that: (1) does not require the selection of the bands of wavelengths passed or rejected at the time of manufacture; (2) allows the selection of any desired combination of bands of wavelengths that are passed or rejected; (3) reduces the time to change the bands of wavelengths passed or rejected; and (4) requires no macro moving parts to accomplish a change in the bands of wavelengths passed or rejected.

In a first aspect, the system of the present invention generally includes one or more radiation sources, a two-dimensional array of modulateable micro-mirrors or an equivalent switching structure, a detector, and an analyzer. In a specific embodiment, the two-dimensional switching array is positioned for receiving an image. The micro-mirrors (or corresponding switching elements of the array) are modulated in order to reflect individual spatially-distributed radiation components of the image toward the detector. In a preferred embodiment, the modulation is performed using known and selectively different modulation rates.

According to this aspect of the invention, a detector is oriented to receive the combined radiation components reflected from the array and is operable to generate an output signal representative of the combined radiation incident thereon. The analyzer is operably coupled with the detector to receive the output signal and to demodulate the signal to recover signals representative of each of the individual spatially distributed radiation components of the image. The analyzer can be configured to recover all reflected components or to reject some unnecessary components of the recovered signals from the combined reflections.

By using micro-mirrors that receive the individual spectral or spatial radiation components and then modulate these components at different modulation rates, all of the radiation components can be focused onto a single detector and then demodulated to maximize the signal-to-noise ratio (SNR) of the detector. Various techniques for enhancing the SNR of the system are presented as well.

In another important aspect, the present invention provides a distinct advance in the state of the art by enabling the design of a controllable radiation source, which uses no masking elements, which are generally slow and cumbersome to operate, and no discrete light sources, which also present a number of technical issues in practice. Instead, the controllable radiation source in accordance with a preferred embodiment is implemented using a broadband source illuminating a two-dimensional array of switching elements, such as a DMA. Modulation of the individual switching elements of the array provides an easy mechanism for spatio-spectral encoding of the input radiation, which encoding can be used in a number of practical applications.

In accordance with another aspect of the invention, a two-dimensional array of switching elements, such as a DMA, can be configured and used as a basic building block for various optical processing tasks, and is referred to as an optical synapse processing unit (OSPU). Combinations of OSPUs with standard processing components can be used in the preferred embodiments of the present invention in a number of practical applications, including data compression, feature extraction and others. In a specific embodiment, a spectrometer using a controlled radiation source provides for very rapid analysis of a sample using an orthogonal set of basis functions, such as Hadamard or Fourier transform techniques, resulting in significantly enhanced signal-to-noise ratio.

The present invention gains the lower-cost, better signal-to-noise, and automatic inter-pixel calibration advantages of single-sensor systems, while not suffering all of the time loss usually associated with using single sensors, because it allows for adaptive and tunable acquisition of only the desired information, as opposed to prior-art systems which are generally full data-cube acquisition devices requiring additional post processing to discover or recover the knowledge ultimately sought in the application of the system. One skilled in the art will recognize that, while the invention here is described using 2D arrays of micro-mirrors, any 2D spatial light modulator can be used. It should also be noted that a pair, or a few 1D spatial light modulators can be combined to effectively produce a 2D spatial light modulator for applications that involve raster scanning, Walsh-Hadamard scanning, or scanning or acquisition with any separable library of patterns.

It is intended that the devices and methods in this application in general are capable of operating in various ranges of electromagnetic radiation, including the ultraviolet, visible, infrared, and microwave spectrum portions. Further, it will be appreciated by those of skill in the art of signal processing, be it acoustic, electric, magnetic, etc., that the devices and techniques disclosed herein for optical signal processing can be applied in a straight-forward way to those other signals as well.

In another important aspect, the invention provides systems and methods for encoded spatio-spectral information processing. In a specific aspect aspect, the invention involves applying or embedding of digital information in the spectral profile of materials, such as inks and paints, to provide the functionality of bar codes or labels, and reading such information from objects. Recording of digital information is enabled onto or into physical media with or without the use of printed symbols, by spraying, mixing or enabling a specific chemical changes resulting in digital information being encoded onto or into carrying materials. Because the information is encoded in the spectral signatures of compositions of materials, the precise location, shape, orientation and arrangement of marks is generally not used in the process of decoding.

Accordingly, in this aspect the invention is a method for encoding information, comprising the steps of: providing two or more materials capable of reacting predictably to one or more radiation components in a given spectral range; selecting a combination of the two or more materials, the selected combination having a spectral response signature in the given spectral range corresponding to one of a plurality of distinct values associated with a predetermined encoding algorithm; and applying the combination of materials to an object in one or more marks, the specific position, arrangement, orientation and shape of a mark with respect to the object or to other marks not being part of the encoding algorithm.

### BRIEF DESCRIPTION OF THE DRAWINGS

The present invention will be understood and appreciated more fully from the following detailed description, taken in conjunction with the drawings in which:

FIGS. 1A and 1B are schematic diagrams illustrating a spectrometer constructed in accordance with two embodiments of the invention;

FIG. 2 is a plan view of a micro-mirror array used in the present invention;

FIG. 3 is a schematic diagram of two micro-mirrors illustrating the modulations of the mirrors of the micro-mirror device of FIG. 2;

FIG. 4 is a graph illustrating an output signal of the spectrometer when used to analyze the composition of a sample;

FIG. 5 is a graph illustrating an output signal of the imager when used for imaging purposes;

FIG. 6 is a schematic diagram illustrating an imager constructed in accordance with a preferred embodiment of the invention; FIG. 6A illustrates spatio-spectral distribution of a DMA, where individual elements can be modulated;

FIG. 7 is an illustration of the input to the DMA Filter Spectrometer and its use to pass or reject wavelength of radiation specific to constituents in a sample;

FIG. 8 illustrates the design of a band pass filter in accordance with the present invention (top portion) and the profile of the radiation passing through the filter (bottom portion);

FIG. 9 illustrates the design of multi-modal band-pass or band-reject filters with corresponding intensity plots, in accordance with the present invention;

FIG. 10 illustrates the means for the intensity variation of a spectral filter built in accordance with this invention;

FIGS. 11-14 illustrate alternative embodiments of a modulating spectrometer in accordance with this invention;

FIGS. 11A and 11B show embodiments in which the DMA is replaced with concave mirrors;

FIG. 12 illustrates an embodiment of a complete modulating spectrometer in which the DMA element is replaced by the concave mirrors of FIG. 11.

FIG. 13 illustrates a modulating lens spectrometer using lenses instead of DMA, and a “barber pole” arrangement of mirrors to implement variable modulation.

FIG. 14. illustrates a “barber pole” modulator arrangement;

FIGS. 15 and 16 illustrate an embodiment of this invention in which one or more light sources provide several modulated spectral bands using a fiber optic bundle;

FIG. 17 illustrates in diagram form an apparatus using controllable radiation source;

FIGS. 18A and 18B illustrate in a diagram form an optical synapse processing unit (OSPU) used as a processing element in accordance with the present invention;

FIG. 19 illustrates in a diagram form the design of a spectrograph using OSPU;

FIG. 20 illustrates in a diagram form an embodiment of a tunable light source;

FIG. 21 illustrates in a diagram form an embodiment of the spectral imaging device, which is built using two OSPUs;

FIGS. 22 and 23 illustrate different devices built using OSPUs;

FIGS. 24-26 are flow charts of various scans used in accordance with the present invention.

Specifically, FIG. 24 is a flow chart of a raster-scan used in one embodiment of the present invention;

FIG. 25 is a flowchart of a Walsh-Hadamard scan used in accordance with another embodiment of the invention.

FIG. 26 is a flowchart of a multi-scale scan, used in a different embodiment; FIG. 26A illustrates a multi-scale tracking algorithm in a preferred embodiment of the present invention;

FIG. 27 is a block diagram of a spectrometer with two detectors;

FIG. 28 illustrates a Walsh packet library of patterns for N=8.

FIG. 29 is a generalized block diagram of hyperspectral processing in accordance with the invention;

FIG. 30 illustrates the difference in two spectral components (red and green) of a data cube produced by imaging the same object in different spectral bands;

FIG. 31A-E illustrate different embodiments of an imaging spectrograph used in accordance with this invention in de-dispersive mode;

FIG. 32 shows an axial and a cross-sectional views of a fiber optic assembly;

FIG. 33 shows a physical arrangement of the fiber optic cable, detector and the slit;

FIG. 34 illustrates a fiber optic surface contact probe head abutting tissue to be examined;

FIGS. 35A and 35B illustrate a fiber optic e-Probe for pierced ears that can be used for medical monitoring applications in accordance with the present invention;

FIGS. 36A, 36B and 36C illustrate different configurations of a hyperspectral adaptive wavelength advanced illuminating imaging spectrograph (HAWAIIS) in accordance with this invention;

FIG. 37 illustrates a DMA search by splitting the scene;

FIG. 38 illustrates wheat spectra data (training) and wavelet spectrum in an example of determining protein content in wheat;

FIG. 39 illustrates the top 10 wavelet packets in local regression basis selected using 50 training samples in the example of FIG. 38;

FIG. 40 is a scatter plot of protein content (test data) vs. correlation with top wavelet packet;

FIG. 41 illustrates PLS regression of protein content of test data;

FIG. 42 illustrates the advantage of DNA-based Hadamard Spectroscopy used in accordance with the present invention over the regular raster scan;

FIGS. 43, 44, 45, 46 and 47(A-D) illustrate hyperspectrum processing in accordance with the present invention;

FIG. 48 illustrates a system for topological application of encoded information, in accordance with a preferred embodiment;

FIG. 49 illustrates an object containing information encoded in a collection of marks, in accordance with the invention. The illustrated marks are of the “bull's eye” pattern, where each mark consists of concentric rings of encoded material;

FIG. 50 illustrates a specific example where the topological application of marks on a rough or variegated surface creates ambiguity about the relative placement of the marks, depending on viewing angle, so that spectral marking according to the present invention is advantageous, in order to recover the ordering of the marks by decoding the information stored in the marks.

FIG. 51 depicts a compact reader in accordance with one embodiment of the present invention, in which a spectrally modulatable light source and a detector are contained in a reading “wand” that can be waived across a mark to read its spectral content.

### DETAILED DESCRIPTION OF THE PREFERRED EMBODIMENTS

In one aspect, the present invention concerns the analysis of radiation passing through or reflected from a sample of a material of interest. Since signal processing in this aspect of the invention is performed after the sample has been irradiated, in the disclosure in Section I below it is referred to as post-sample processing. Section II deals with the aspect of the invention in which radiation has already been processed prior to its interaction with the sample (e.g. based on a priori knowledge), and is accordingly referred to as pre-sample processing. Various processing techniques applicable in both pre-sample and post-sample processing are considered in Section III. Finally, Section IV illustrates the use of the proposed techniques and approaches in the description of various practical applications.

I. Post-Sample Processing

A. The Basic System

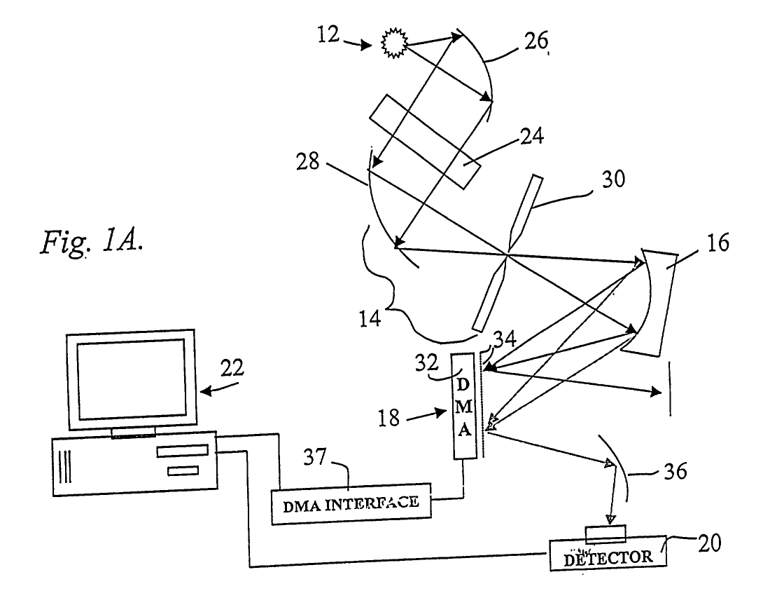

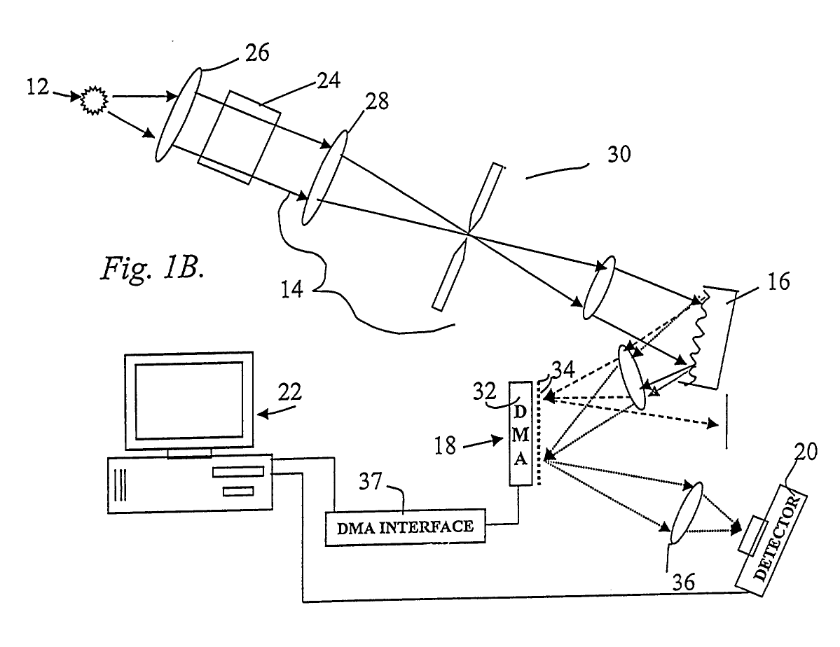

Turning now to the drawing figures and particularly FIG. 1A and 1B, a spectrometer assembly 10 constructed in accordance with one embodiment of the invention is illustrated. With reference to FIG. 1A the device broadly includes a source 12 of electromagnetic radiation, a mirror and slit assembly 14, a wavelength dispersing device 16, a spatial light modulator 18, a detector 20, and an analyzing device 22.

In particular, the electromagnetic radiation source 12 is operable to project rays of radiation onto or through a sample 24 that is to be analyzed, such as a sample of body tissue or blood. The radiation source may be any device that generates electromagnetic radiation in a known wavelength spectrum such as a globar, hot wire, or light bulb that produces radiation in the infrared spectrum. To increase the amount of rays that are directed to the sample, a parabolic reflector 26 may be interposed between the source 12 and the sample 24. In a specific embodiment, the source of electromagnetic radiation is selected as to yield a continuous band of spectral energies, and is referred to as the source radiation. It should be apparent that the energies of the radiation source are selected to cover the spectral region of interest for the particular application.

The mirror and slit assembly 14 is positioned to receive the radiation rays from the source 12 after they have passed through the sample 24 and is operable to focus the radiation onto and through an entrance slit 30. The collection mirror 28 focuses the radiation rays through slit 30 and illuminates the wavelength dispersing device 16. As shown in diagram form in FIG. 1B, in different embodiments of the invention radiation rays from the slit may also be collected through a lens 15, before illuminating a wavelength dispersion device 16.

The wavelength dispersing device 16 receives the beams of radiation from the mirror and slit assembly 14 and disperses the radiation into a series of lines of radiation each corresponding to a particular wavelength of the radiation spectrum. The preferred wavelength dispersing device is a concave diffraction grating; however, other wavelength dispersing devices, such as a prism, may be utilized. In a specific embodiment, the wavelengths from the dispersing device 16 are in the near infrared portion of the spectrum and may cover, for example, the range of 1650-1850 nanometers (nm). It should be emphasized, however, that in general this device is not limited to just this or to any spectral region. It is intended that the dispersion device in general is capable of operating in other ranges of electromagnetic radiation, including the ultraviolet, visible, infrared, and microwave spectrum portions, as well as acoustic, electric, magnetic, and other signals, where applicable.

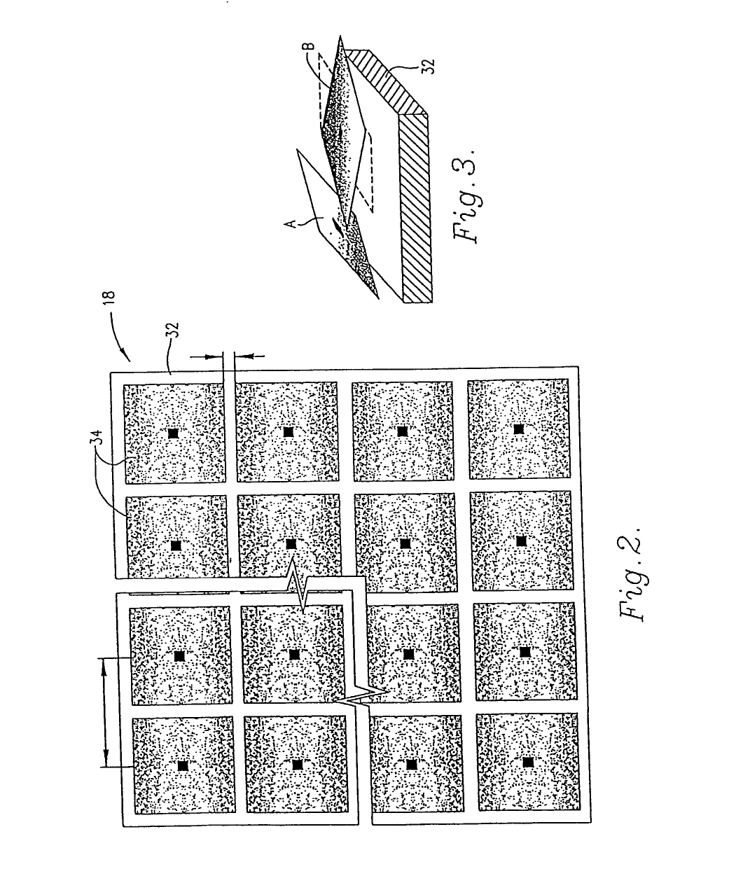

The spatial light modulator (SLM) 18 receives radiation from the wavelength dispersing device 16, individually modulates each spectral line, and reflects the modulated lines of radiation onto the detector 20. As illustrated in FIG. 2, the SLM is implemented in a first preferred embodiment as a micro-mirror array that includes a semi-conductor chip or piezo-electric device 32 having an array of small reflecting surfaces 34 thereon that act as mirrors. One such micro-mirror array is manufactured by Texas Instruments and is described in more detail in U.S. Pat. No. 5,061,049, hereby incorporated into the present application by reference. Those skilled in the art will appreciate that other spatial light modulators, such as a magneto-optic modulator or a liquid crystal device may be used instead of the micro-mirror array. Various embodiments of such devices are discussed in more detail below.

The semi-conductor 32 of the micro-mirror array 18 is operable to individually tilt each mirror along its diagonal between a first position depicted by the letter A and a second position depicted by the letter B in FIG. 3. In preferred forms, the semi-conductor tilts each mirror 10 degrees in each direction from the horizontal. The tilting of the mirrors 34 is preferably controlled by the analyzing device 22, which may communicate with the micro-mirror array 18 through an interface 37.

The micro-mirror array 18 is positioned so that the wavelength dispersing device 16 reflects each of the lines of radiation upon a separate column or row of the array. Each column or row of mirrors is then tilted or wobbled at a specific and separate modulation frequency. For example, the first row of mirrors may be wobbled at a modulation frequency of 100 Hz, the second row at 200 Hz, the third row at 300 Hz, etc.

In a specific embodiment, the mirrors are calibrated and positioned so that they reflect all of the modulated lines of radiation onto a detector 20. Thus, even though each column or row of mirrors modulates its corresponding line of radiation at a different modulation frequency, all of the lines of radiation are focused onto a single detector.

The detector 20, which may be any conventional radiation transducer or similar device, is oriented to receive the combined modulated lines of radiation from the micro-mirror array 18. The detector is operable for converting the radiation signals into a digital output signal that is representative of the combined radiation lines that are reflected from the micro-mirror array. A reflector 36 may be interposed between the micro-mirror array 18 and the detector 20 to receive the combined modulated lines of radiation from the array and to focus the reflected lines onto the detector.

The analyzing device 22 is operably coupled with the detector 20 and is operable to receive and analyze the digital output signal from the detector. The analyzing device uses digital processing techniques to demodulate the signal into separate signals each representative of a separate line of radiation reflected from the micro-mirror array. For example, the analyzing device may use discrete Fourier transform processing to demodulate the signal to determine, in real time, the intensity of each line of radiation reflected onto the detector. Thus, even though all of the lines of radiation from the micro-mirror array are focused onto a single detector, the analyzing device can separately analyze the characteristics of each line of radiation for use in analyzing the composition of the sample.

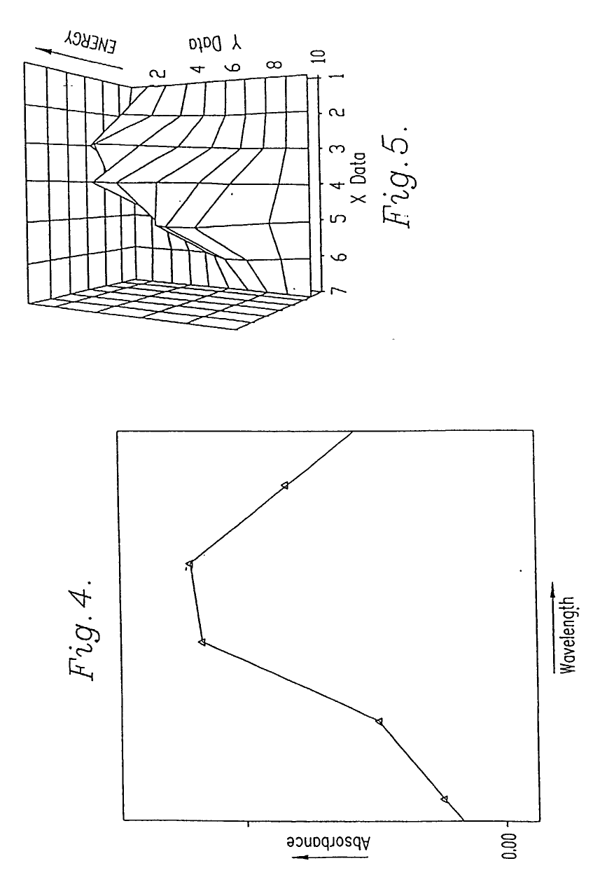

In accordance with one embodiment of this invention, the analyzing device is preferably a computer that includes spectral analysis software. FIG. 4 illustrates an output signal generated by the analyzing device in accordance with one embodiment. The output signal illustrated in FIG. 4 is a plot of the absorption characteristics of five wavelengths of radiation from a radiation source that has passed through a sample.

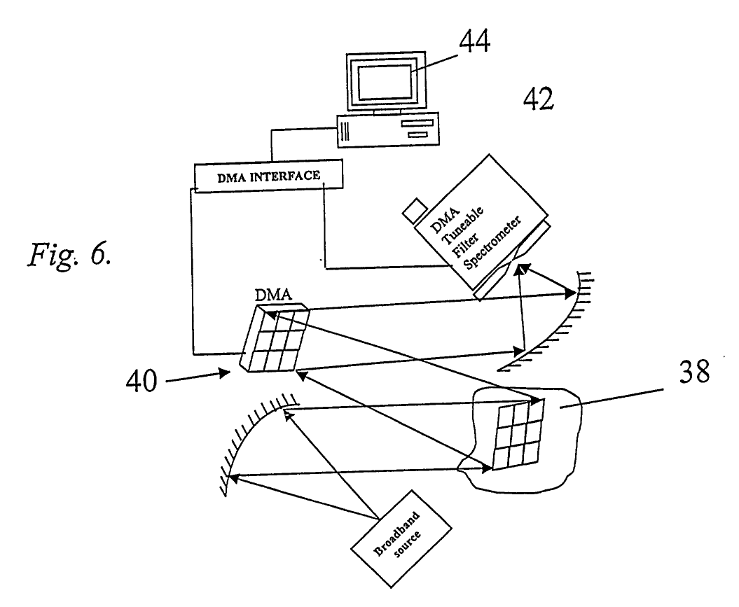

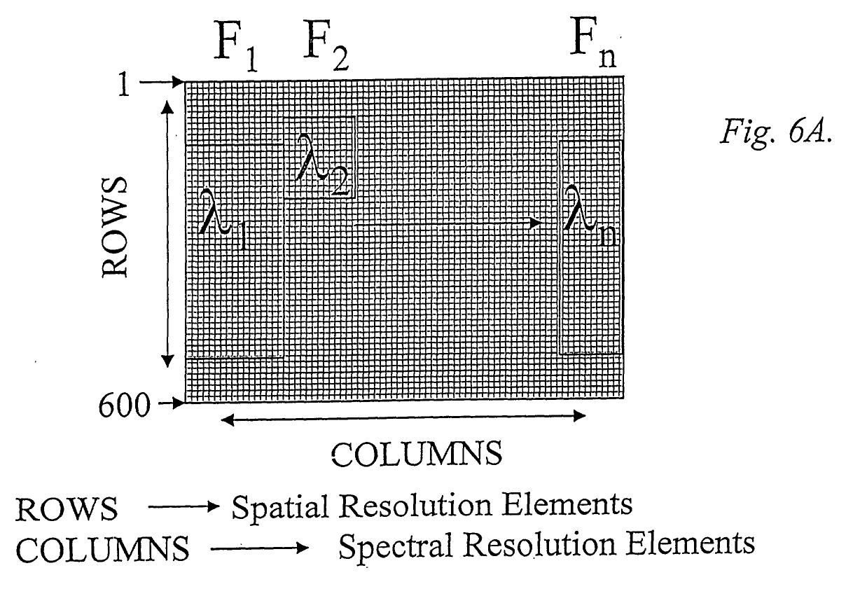

In one embodiment of the system of this invention illustrated in FIG. 6A, it is used for digital imaging purposes. In particular, when used as an imaging device, an image of a sample 38 is focused onto a micro-mirror array 40 and each micro-mirror in the array is modulated at a different modulation rate. The micro-mirror array geometry is such that some or all of the reflected radiation impinges upon a single detector element 42 and is subsequently demodulated to reconstruct the original image improving the signal-to-noise ratio of the imager. Specifically, an analyzing device 44 digitally processes the combined signal to analyze the magnitude of each individual pixel. FIG. 6B illustrates spatio-spectral distribution of the DMA, where individual elements can be modulated. FIG. 5 is a plot of a three dimensional image showing the magnitude of each individual pixel.

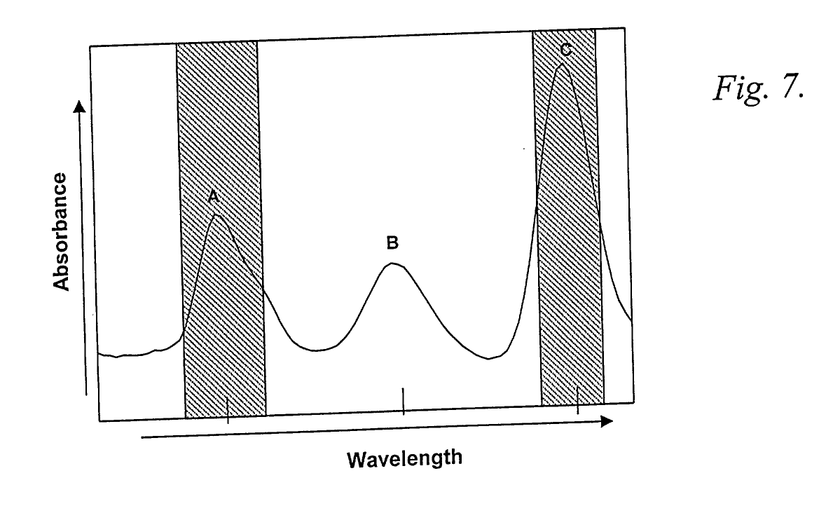

FIG. 7 illustrates the output of a digital micro-mirror array (DMA) filter spectrometer used as a variable band pass filter spectrometer, variable band reject filter spectrometer, variable multiple band pass filter spectrometer or variable multiple band reject filter spectrometer. In this embodiment, the combined measurement of the electromagnetic energy absorbed by sample constituents A and C is of interest. The shaded regions in FIG. 7 illustrate the different regions of the electromagnetic spectrum that will be allowed to pass to the detector by the DMA filter spectrometer. The wavelengths of electromagnetic radiation selected to pass to the detector correspond to the absorption band for compound A and absorption band for compound C in a sample consisting of compounds A, B, and C. The spectral region corresponding to the absorption band of compound B and all other wavelengths of electromagnetic radiation are rejected. Those skilled in the art will appreciate that the DMA filter spectrometer is not limited to the above example and can be used to pass or reject any combination of spectral resolution elements available to the DMA. Various examples and modifications are considered in detail below.

As a DMA filter imager the spatial resolution elements (pixels) of an image can be selectively passed or rejected (filtered) according to the requirements of the image measurement. The advantages of both the DMA filter spectrometer and DMA filter imager are:

(1) All spectral resolution elements or spatial resolution elements corresponding to the compounds of interest in a particular sample can be directed simultaneously to the detector for measurement. This has the effect of increasing the signal-to-noise ratio of the measurement.

(2) The amount of data requiring processing is reduced. This reduces storage requirements and processing times.

B. Modulated Spectral Filter Design

(i) Design Basics

The preceding section described the components of the basic system used in accordance with the present invention, and their operation. The focus of this section is on the design of specific modulated spectral filters using the spatial light modulator (SLM) 18, which in a preferred embodiment is implemented using a digital micro-mirror array (DMA).

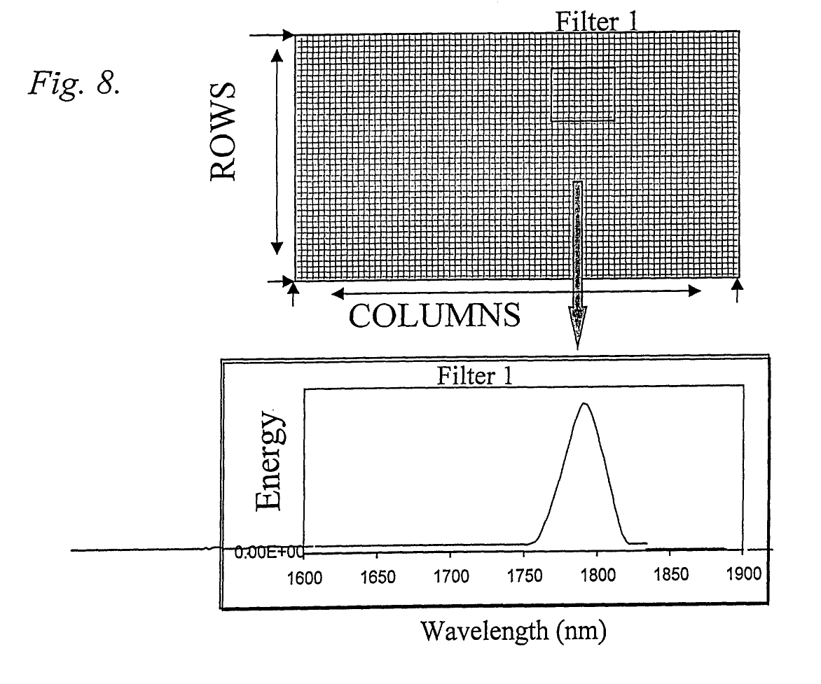

As noted above, using a DMA one can provide one or more spectral band pass or band-reject filter(s) with a chosen relative intensity. In particular, in accordance with the present invention the radiation wavelengths that are reflected in the direction of the detector are selected by specific columns of micro-mirrors of the DMA, as illustrated in FIG. 8. The relative intensity of the above spectral band is controlled by the selection of specific area of micro-mirrors on the DMA, represented by the dark area designated “A” in FIG. 8. Thus, the dark area shown in FIG. 8 is the mirrors that direct specific wavelength radiation, i.e., spectral band, to the detector. Clearly, the “on” mirrors in the dark area create a band-pass filter, the characteristics of which are determined by the position of the “on” area in the DMA. The bottom portion of the figure illustrates the profile of the radiation reaching the detector.

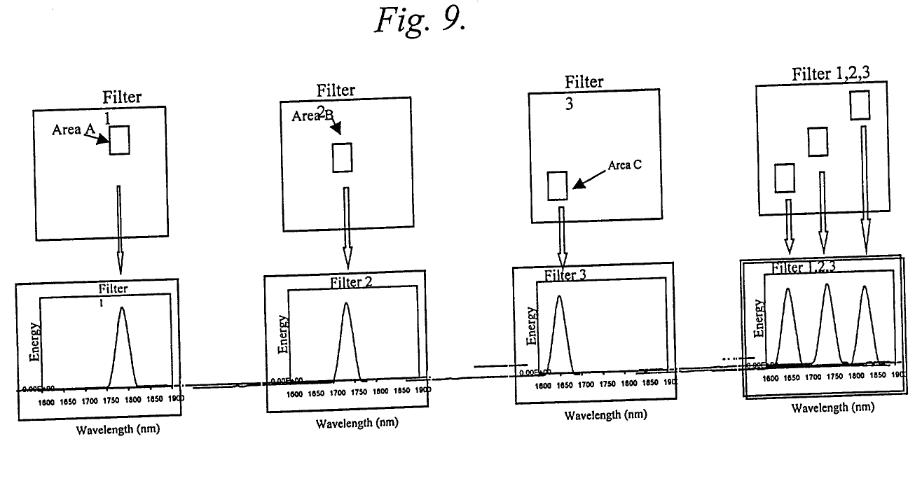

FIG. 8 also demonstrates the selection of specific rows and columns of mirrors in the DMA used to create one spectral band filter with a single spectral mode. It should be apparent, however, that using the same technique of blocking areas in the DMA one can obtain a plurality of different specific spectral band filters, which can have multi-modal characteristics. The design of such filters is illustrated in FIG. 9.

As shown in FIG. 9, a multitude of different specific filters can be designed on one DMA using simple stacking. FIG. 9 illustrates the creation of several filters by selective reflection from specific micro-mirrors. In particular, the left side of the figure illustrates the creation of three different filters, designated 1, 2, and 3. This is accomplished by the selection of specific mirrors on the DMA, as described above with reference to FIG. 8. The total collection of spectral band filters is shown at the bottom-left of this figure. The spectral band provided by each filter is shown on the right-hand side of the figure. The bottom right portion illustrates the radiation passing through the combination of filters 1, 2 and 3.

The above discussion describes how the relative intensity of each spectral band can be a function of the DMA area used in the reflection. The following table illustrates the linear relationship between areas of the DMA occupied by individual filters, and the resulting filter. Clearly, if the entire DMA array is in the “on” position, there will be no filtering and in principle the input radiation passes through with no attenuation.

| FIG. 9, left side | FIG. 9, right side |
|---|---|
| Reflected radiation from micro-mirrors | Filter created |
| area A | 1 |
| area B | 2 |
| area C | 3 |
| areas a + b + c | 1 + 2 + 3 |

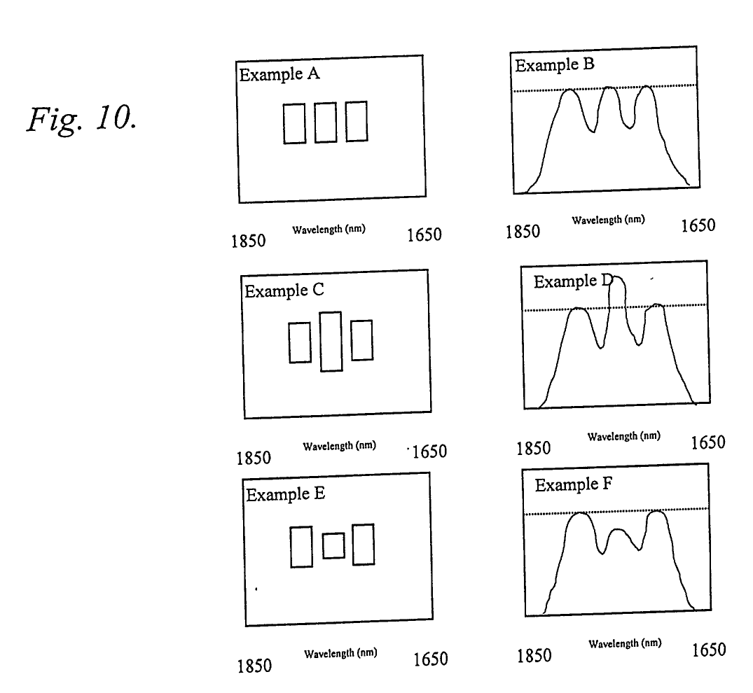

FIG. 10 illustrates the means for the intensity variation of a spectral filter built in accordance with this invention, and is summarized in the table below.

| Example A | Example B |
|---|---|
| Reflection from a DMA | The intensity recorded at the |
| See FIGS. 8 and 9. | detector for example A for the |
| Reflection areas 1, 2, and 3 create | combination filter 1, 2, and 3, |
| spectral filter 1, 2 and 3 respectively. | Intensity, I, I₁ = I₂ = I₃ |
| area 1 = area 2 = area 3 | |
| Example C | Example D |
| The reflection of area 2 of the DMA | The intensity recorded at the |
| is increased. | detector for filters 1, 2, and 3 is |
| area 1 = area 3 < area 2 | I₁ ≈ I₃ < I₂ |
| Example E | Example F |
| The reflection of area 2 of the DMA | The intensity recorded at the |
| is decreased | detector for filter 1, 2, and 3 is |
| area 1 = area 3 < area 2 | I₁ = I₃ < I₂ |

(ii) Modulation

FIGS. 9 and 10 illustrate the ability to design spectral filters with different characteristics using a DMA. The important point to keep in mind is that different spectral components of the radiation from the sample have been separated in space and can be filtered individually. It is important to retain the ability to process individual spectral components separately. To this end, in accordance with the present invention, spectral components are modulated.

The basic idea is to simply modulate the output from different filters differently, so one can identify and process them separately. In a preferred embodiment, different modulation is implemented by means of different modulation rates. Thus, with reference to FIG. 9, the output of filter 1 is modulated at rate M₁; output of filter 2 is modulated at rate M₂, and filter 3 is modulated using rate M₃, where M₁≠M₂≠M₃. In different embodiments, modulation may be achieved by assigning a different modulation encodement to each filter, with which it is modulated over time.

As a result, a system built in accordance with the present invention is capable of providing: a) Spectral bandwidth by selection of specific columns of micro-mirrors in an array; b) Spectral intensity by selection of rows of the array; and c) Spectral band identification by modulation. All of the above features are important in practical applications, as discussed in Section IV below.

C. Alternative Embodiments

(i) Modulating Spectrometers Without a DMD.

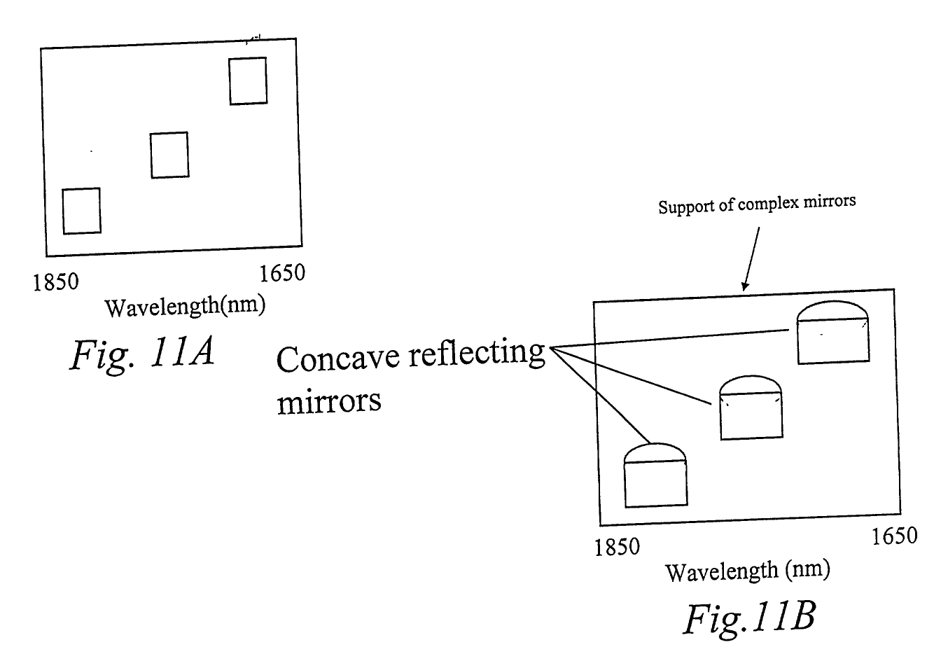

FIGS. 11-14 illustrate alternative embodiments of a modulating spectrometer in accordance with this invention, where the DMA is replaced with different components. In particular, FIGS. 11A and B show an embodiment in which the DMA is replaced with fixed elements, in this case concave mirrors. The idea is to use fixed spectral grating, which masks out spectrum block components that are not needed and passes those which are.

The idea here is that the broadly illuminated dispersive element distributes spectral resolution elements in one dimension so that in the orthogonal dimension one can collect light of the same wavelengths. With reference to FIG. 6A one can see that at a particular defined plane, herein called the focal plane, one has a wavelength axis(x or columns) and a spatial axis(y or rows). If one were to increase the number of spatial resolution elements (y) that are allowed to pass energy through the system and out of the exit aperture for any given wavelength (x), or spectral resolution element (x), this would have the effect of increasing the intensity of the particular spectral resolution elements' intensity at the detector.

If the array of spatio/spectral resolution elements at the focal plane as shown in FIG. 6A is replaced with fixed elements, such as the concave mirrors in FIG. 11B, one can have a different device configured to perform a particular signal processing task—in this case pass the predetermined spectrum components at the desired intensity levels. FIG. 11A shows the spatio/spectral resolution elements at the focal plane to be used. The fixed optical elements are placed to interact with predetermined spatio/spectral resolution elements provided by the grating and entrance aperture geometry and to direct the specific assortment of spatio/spectral elements to specific spatial locations for modulation encoding (possibly using the barber pole arrangement, shown next).

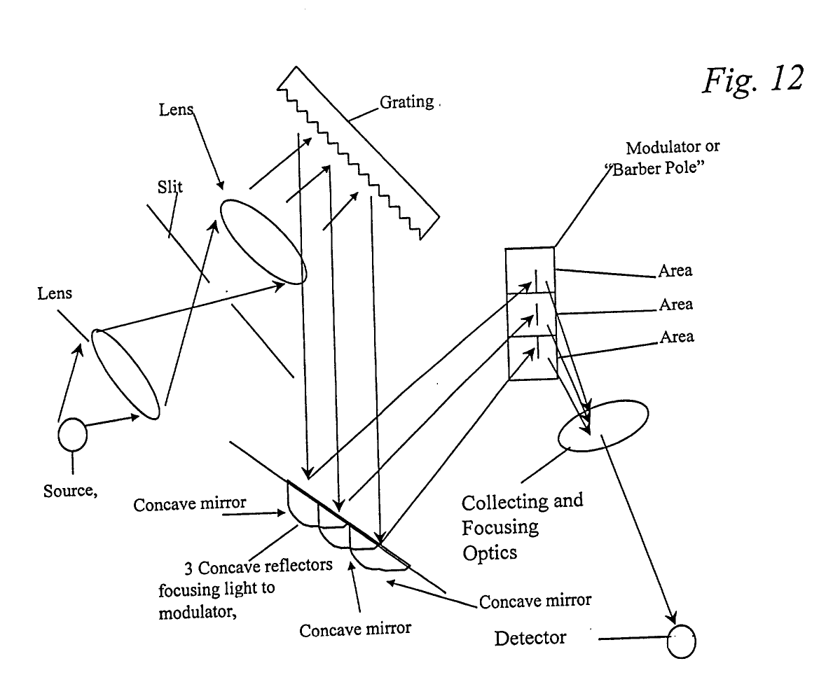

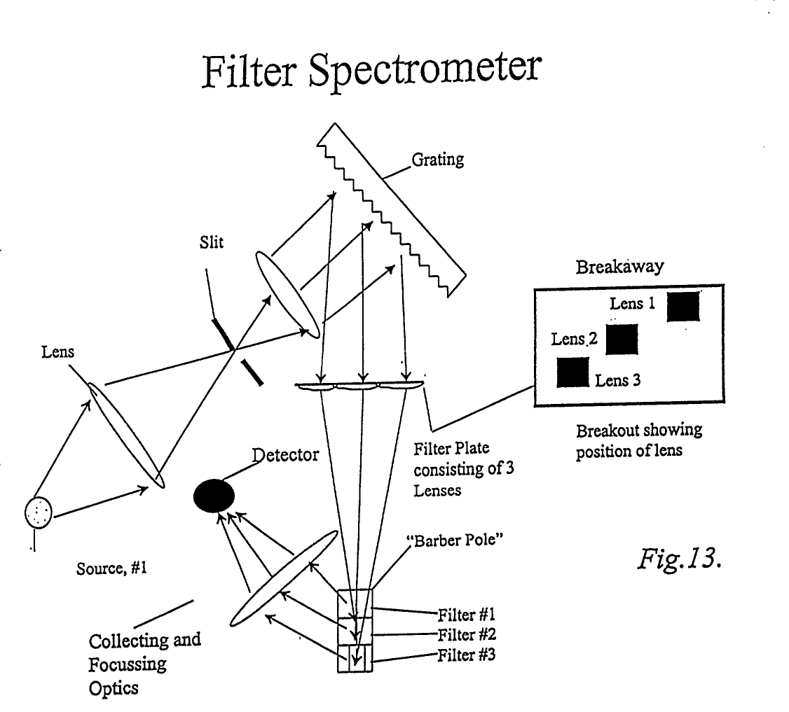

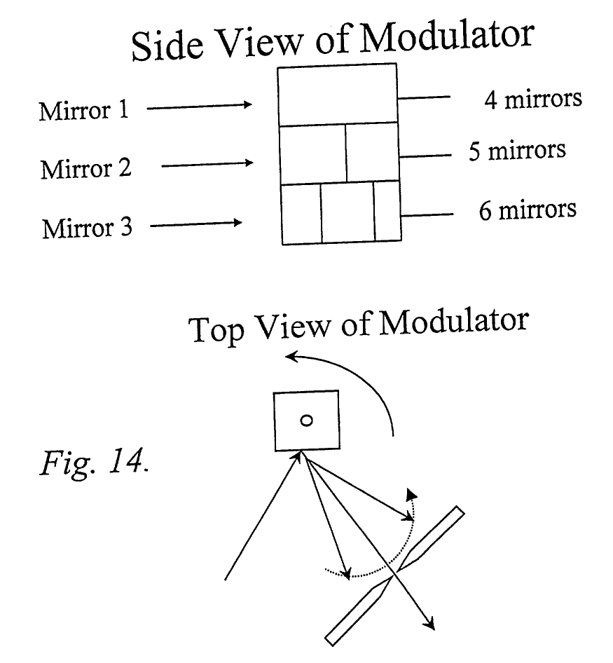

FIG. 12 illustrates an embodiment of a complete modulating spectrometer in which the DMA element is replaced by the concave mirrors of FIG. 11. FIG. 13 illustrates a modulating lens spectrometer using lenses instead of DMA, and a “barber pole” arrangement of mirrors to implement variable modulation. The “barber pole” modulation arrangement is illustrated in FIG. 14.

With reference to FIG. 14, modulation is accomplished by rotating this “barber pole” that has different number of mirrors mounted for reflecting light from the spatially separated spectral wavelengths. Thus, irradiating each vertical section will give the reflector its own distinguishable frequency. In accordance with this embodiment, light from the pole is collected and simultaneously sent to the detector. Thus, radiation from concave mirror 1 impinges upon the four-mirror modulator; concave mirror 2 radiation is modulated by the five-mirror modulator, and concave mirror 3 directs radiation to the six-mirror modulator. In the illustrated embodiment, the modulator rate is four, five, or six times per revolution of the “barber pole.”

The operation of the device is clarified with reference to FIG. 12, tracing the radiation from the concave mirrors 12 to the detector of the system. In particular, concave mirror 1 reflects a selected spectral band with chosen intensity. This radiated wave impinges upon a modulator, implemented in this embodiment as a rotation barber pole. The modulating rates created by the barber pole in the exemplary embodiment shown in the figure are as shown in the table below.

| | Number of mirrors | Modulation |
|---|---|---|
| | Per 360° rotation | Per 360° of barber pole |
| Area A | 4 | 4/360° |
| Area B | 5 | 5/360° |
| Area C | 6 | 6/360° |

Accordingly, this arrangement yields a modulation rate of 4/360° for the radiation from Area A, FIG. 12.

By a analogy, the mirrors of Areas B and C are modulated at the rate of 5/360° and 6/360°, respectively. As illustrated, all radiation from mirrors A, B, and C is simultaneously directed to the detector. This radiation is collected by either a simple mirror lens or a toroidal mirror, which focuses the radiation onto a single detector. The signal from the detector now goes to electronic processing and mathematical analyses for spectroscopic results.

(ii) Modulating Light Sources Spectrometer.

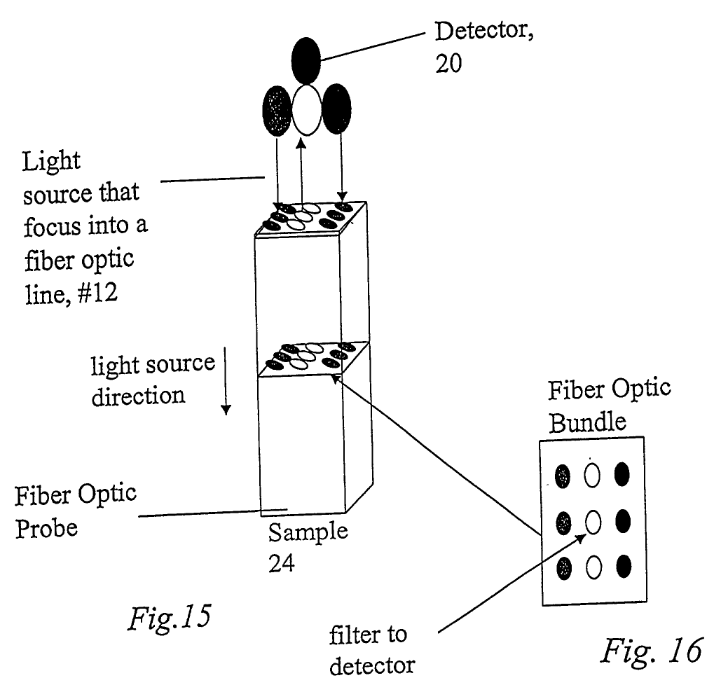

In the discussion of modulating spectrometers, a single light source of electromagnetic radiation was described. There exist yet another possibility for a unique optical design—a modulating multi-light source spectrometer. FIGS. 15 and 16 illustrate an embodiment of this invention in which a light source 12 provides several modulated spectral bands, e.g., light emitting diodes (LED), or lasers (shown here in three different light sources). The radiation from these light sources impinges upon the sample 24. One possible illumination design is one in which light from a source, e.g. LED, passes through a multitude of filters, impinging upon the sample 24. The radiation from the sample is transmitted to a detector 20, illustrated as a black fiber. The signal from the detector is electronically processed to a quantitative and qualitative signal describing the sample chemical composition.

In this embodiment, a plurality of light sources is used at differed modulating rates. FIGS. 15 and 16 illustrate the combination of several light sources in the spectrometer. The choice of several different spectral bands of electromagnetic radiation can be either light emitting diodes, LED, lasers, black body radiation and/or microwaves. Essentially the following modulation scheme can be used to identify the different light sources, in this example LED's of different spectral band wavelength.

| No. of | Spectral band | Modulation |
|---|---|---|
| Source | Wavelength, nm | Rate |
| 1 | 1500-1700 | m₁ |
| 2 | 1600-1800 | m₂ |
| 3 | 1700-1900 | m₃ |
| . | . | . |
| . | . | . |
| . | . | . |

Note: m₁ ≠ m₂ ≠ m₃ ≠ . . .

It should be noted that either the radiation will be scattered or transmitted by the sample 24. This scattered or transmitted radiation from the sample is collected by an optical fiber. This radiation from the sample is conducted to the detector. The signal from the detector is electronically processed to yield quantitative and qualitative information about the sample.

In a particular embodiment the radiation path consists of optical fibers. However, in accordance with alternate embodiments, mirrors and lenses could also constitute the optical path for a similar modulating multi-light source spectrometer.

(iii) Modulating Multi-Source Hyperspectral Imaging Spectrometer

The spectrometer described in the preceding section records spectral information about one unique area on a single detector. In a similar manner, the spectral characteristic of a multitude of areas in a sample can be recorded with a multitude of detectors in accordance with different embodiments of the invention. Such a multitude of detectors exists in an array detector. Array detectors are known in the art and include, for example

Charge coupled devices (CCD), in the ultraviolet, and visible portions of the spectrum; InSb—array in near infrared; InGaAs—array in near infrared; Hg—Cd—Te—array in mid-infrared and other array detectors.

Array detectors can operate in the focal plane of the optics. Here each detector of the array detects and records the signal from a specific area, xᵢyᵢ. Practical Example B in Section IV on the gray-level camera provides a further illustration. Different aspects of the embodiments discussed in sections (iii) and (iv) are considered in more detail in the following sections. As is understood by one skilled in the art, standard optical duality implies that each of the preceding configurations can be operated in reverse, exchanging the position of the source and the detector.

II. Pre-Sample Processing

The preceding section described an aspect of the invention referred to as post-sample processing, i.e., signal processing performed after a sample had been irradiated. In accordance with another important aspect of this invention, significant benefits can result from irradiating a sample with pre-processed radiation, in what is referred to as pre-sample processing. Most important in this context is the use, in accordance with this invention, of one or more light sources, capable of providing modulated temporal and/or spatial patterns of input radiation. These sources are referred to next as controllable source(s) of radiation, which in general are capable of generating arbitrary combinations of spectral radiation components within a predetermined spectrum range.

Several types of prior art devices are known that are capable of providing controllable radiation. Earlier prior art devices primarily relied upon various “masking” techniques, such as electronically alterable masks interposed in the optical pathway between a light source and a detector. More recent prior art devices use a combination of two or more light-emitting diodes (LEDs) as radiation sources. Examples are provided in U.S. Pat. Nos. 5,257,086 and 5,488,474, the content of which is hereby incorporated by reference for all purposes. As discussed in the above patents, an array of LEDs or light-emitting lasers is configured for activation using a particular encoding pattern, and can be used as a controllable light source. A disadvantage of this system is that it relies on an array of different LED elements, each operating in a different, relatively narrow spectrum band. In addition, there are technological problems associated with having an array of discrete radiation elements with different characteristics.

These and other problems associated with the prior art are addressed in accordance with the present invention using a device that in a specific embodiment can be thought of as the reverse of the setup illustrated in FIG. 1A. In particular, one or more broadband radiation sources illuminate the digital micro-mirror array (DMA) 18 and the modulations of the micro-mirrors in the DMA encode the source radiation prior to impinging upon the sample. The reflected radiation is then collected from the sample and directed onto a detector for further processing.

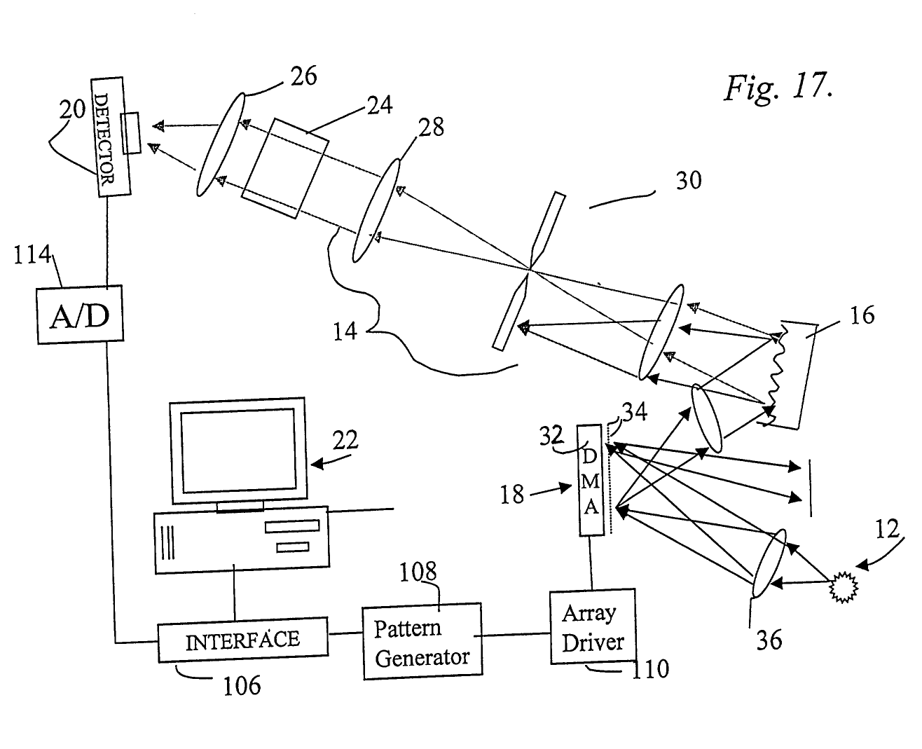

FIG. 17 illustrates a schematic representation of an apparatus in accordance with the present invention using a controllable radiation source. Generally, the system includes a broadband radiation source 12, DMA 18, wavelength dispersion device 16, slit assembly 30, detector 20 and control assembly 22.

In particular, control assembly 22 may include a conventional personal computer 104, interface 106, pattern generator 108, DMA driver 110, and analog to digital (A/D) converter 114. Interface 106 operates as a protocol converter enabling communications between the computer 22 and devices 108-114.

Pattern generator 108 may include an EPROM memory device (not shown) which stores the various encoding patterns for array 18, such as the Hadamard encoding pattern discussed below. In response to control signals from computer 22, generator 108 delivers signals representative of successive patterns to driver 110. More particularly, generator 108 produces output signals to driver 110 indicating the activation pattern of the mirrors in the DMA 18. A/D converter 114 is conventional in nature and receives the voltage signals from detector 20, amplifies these signals as analog input to the converter in order to produce a digital output representative of the voltage signals.

Radiation source 12, grating 16, DMA 18 slit assembly 30 and detector 20 cooperatively define an optical pathway. Radiation from source 12 is passed through a wavelength dispersion device, which separates in space different spectrum bands. The desired radiation spectrum can them be shaped by DMA 18 using the filter arrangement outlined in Section I(B)(i). In accordance with a preferred embodiment, radiation falling on a particular micro-mirror element can also be encoded with a modulation pattern applied to it. In a specific mode of operating the device, DMA 18 is activated to reflect radiation in a successive set of encoding patterns, such as Hadamard, Fourier, wavelet or others. The resultant set of spectral components is detected by detector 20, which provides corresponding output signals. Computer 22 then processes these signals.

Computer 22 initiates an analysis by prompting pattern generator 108 to activate the successive encoding patterns. With each pattern, a set of wavelength components are resolved by grating 16 and after reflection from the DMA 18 is directed onto detector 20. Along with the activation of encoding patterns, computer 22 also takes readings from A/D converter 114, by sampling data. These readings enable computer 22 to solve a conventional inverse transform, and thereby eliminate background noise from the readings for analysis.

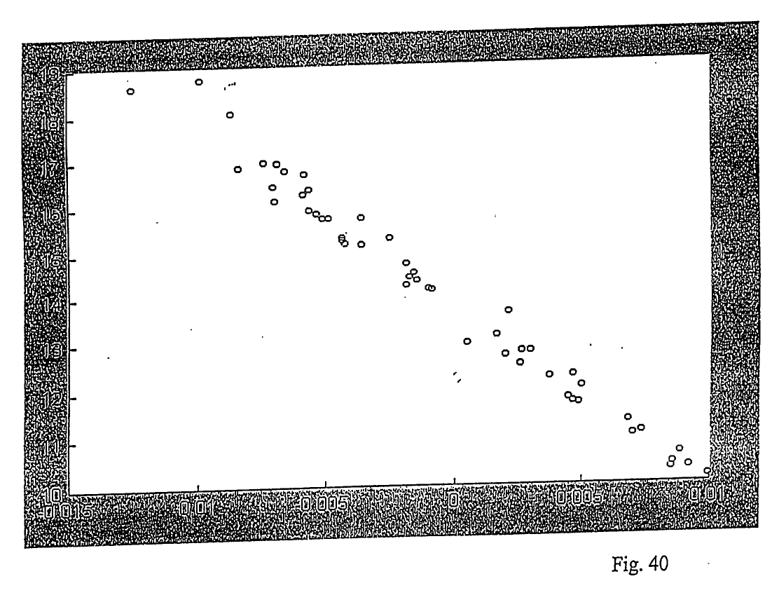

In summary, the active light source in accordance with the present invention consists of one or more light sources, from which various spectral bands are selected for transmission, while being modulated with a temporal and/or spatial patterns. The resulting radiation is then directed at a region (or material) of interest to achieve a variety of desired tasks. A brief listing of these tasks include: (a) Very precise spectral coloring of a scene, for purposes of enhancement of display and photography; (b) Precise illumination spectrum to correspond to specific absorption lines of a compound that needs to be detected, (see FIGS. 40-44 on protein in wheat as an illustration) or for which it is desirable to have energy absorption and heating, without affecting neighboring compounds (This is the principle of the microwave oven for which the radiation is tuned to be absorbed by water molecules allowing for heating of moist food only); (c) The procedure in (b) could be used to imprint a specific spectral tag on ink or paint, for watermarking, tracking and forgery prevention, acting as a spectral bar code encryption; (d) The process of light curing to achieve selected chemical reactions is enabled by the tunable light source.

Various other applications are considered in further detail in Section IV. Duality allows one to reverse or “turn inside out” any of the post-sample processing configurations described previously, to yield a pre-sample processing configuration. Essentially, in the former case one takes post sample light, separates wavelengths, encodes or modulates each, and detects the result. The dualized version for the latter case is to take source light, separates wavelengths, encode or modulate each, interact with a sample, and detect the result

III. Data Encoding, Decoding and Signal Processing

The preceding two sections disclosed various embodiments of systems for performing post- and pre-sample processing. In a specific embodiment, the central component of the system is a digital micro-mirror array (DMA), in which individual elements (micro-mirrors) can be controlled separately to either pass along or reject certain radiation components. By the use of appropriately selected modulation patterns, the DMA array can perform various signal processing tasks. In a accordance with a preferred embodiment of this invention, the functionality of the DMAs discussed above can be generalized using the concept of Spatial Light Modulators (SLMs), devices that broadly perform spatio-spectral encoding of individual radiation components, and of optical synapse processing units (OSPUs), basic processing blocks. This generalization is considered in subsection III.A, followed by discussions of Hadamard processing, spatio-spectral tagging, data compression, feature extraction and other signal processing tasks.

A. Basic Building Blocks

(i) Spatial Light Modulators (SLMs)

In accordance with the present invention, one-dimensional (1D), two-dimensional (2D) or three-dimensional (3D) devices capable of acting as a light valve or array of light valves are referred to as spatial light modulators (SLMs). More broadly, an SLM in accordance with this invention is any device capable of controlling the magnitude, power, intensity or phase of radiation or which is otherwise capable of changing the direction of propagation of such radiation. This radiation may either have passed through, or be reflected or refracted from a material sample of interest. In a preferred embodiment, an SLM is an array of elements, each one capable of controlling radiation impinging upon it. Note that in accordance with this definition an SLM placed in appropriate position along the radiation path can control either spatial or spectral components of the impinging radiation, or both. Furthermore, “light” is used here in a broad sense to encompass any portion of the electromagnetic spectrum and not just the visible spectrum. Examples of SLM's in accordance with different embodiments of the invention include liquid crystal devices, actuated micro-mirrors, actuated mirror membranes, di-electric light modulators, switchable filters and optical routing devices, as used by the optical communication and computing environments and optical switches. In a specific embodiment, Sections IA and IB discussed the use of a DMA as an example of spatial light modulating element. U.S. Pat. No. 5,037,173 provides examples of technology that can be used to implement SLM in accordance with this invention, and is hereby incorporated by reference.

In a preferred embodiment, a 1D, 2D, or 3D SLM is configured to receive any set of radiation components and functions to selectively pass these components to any number of receivers or image planes or collection optics, as the application may require, or to reject, reflect or absorb any input radiation component, so that either it is or is not received by one or more receivers, image planes or collection optics devices. It should be clear that while in the example discussed in Section I above the SLM is implemented as a DMA, virtually any array of switched elements may be used in accordance with the present invention.

Generally, an SLM in accordance with the invention is capable of receiving any number of radiation components, which are then encoded, tagged, identified, modulated or otherwise changed in terms of direction and/or magnitude to provide a unique encodement, tag, identifier or modulation sequence for each radiation component in the set of radiation components, so that subsequent optical receiver(s) or measuring device(s) have the ability to uniquely identify each of the input radiation components and its properties. In a relevant context, such properties include, but are not limited to, irradiance, wavelength, band of frequencies, intensity, power, phase and/or polarization. In Sections I and II above, tagging of individual radiation components is accomplished using rate modulation. Thus, in Section I, different spectral components of the input radiation that have been separated in space using a wavelength dispersion device are then individually encoded by modulating the micro-mirrors of the DMA array at different rates. The encoded radiation components are directed to a single detector, but nevertheless can be analyzed individually using Fourier analysis of the signal from the detector. Other examples for the use of “tagging” are discussed below.

(ii) The Optical Synapse Processing Unit (OSPU)

In accordance with this invention, various processing modalities can be realized with an array of digitally controlled switches (an optical synapse), which function to process and transmit signals between different components of the system. In the context of the above description, the basic OSPU can be thought of as a data acquisition unit capable of scanning an array of data, such as an image, in various modes, including raster, Hadamard, multiscale wavelets, and others, and transmitting the scanned data for further processing. Thus, a synapse is a digitally controlled array of switches used to redirect image (or generally data) components or combinations of light streams, from one location to one or more other locations. In particular it can perform Hadamard processing, as defined below, on a plurality of radiation elements by combining subsets of the elements (i.e., binning) before conversion to digital data. A synapse can be used to modulate light streams by modulating temporally the switches to impose a temporal bar code (by varying in time the binning operation). This can be built in a preferred embodiment from a DMA, or any of a number of optical switching or routing components, used for example in optical communications applications.

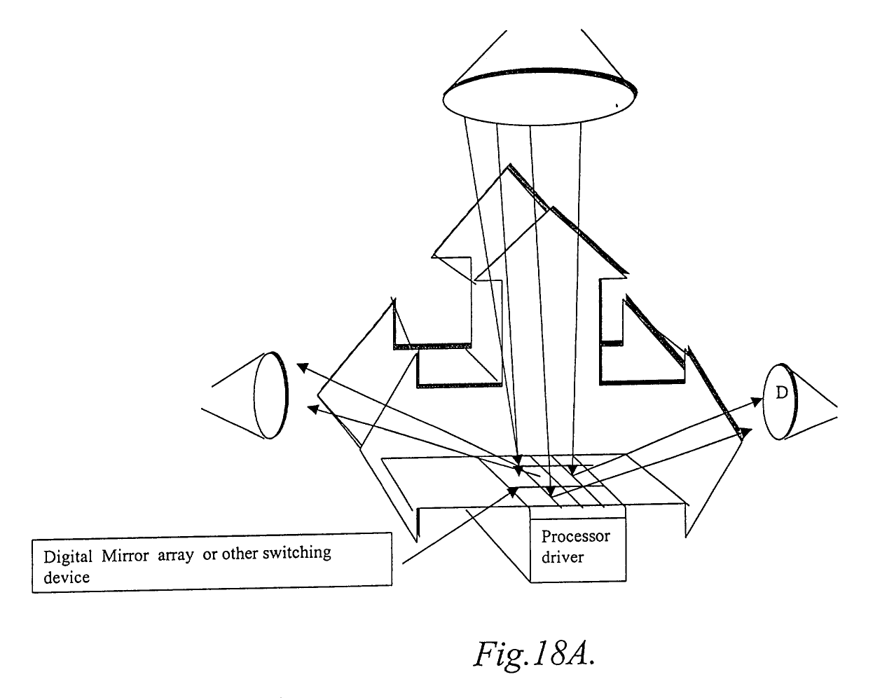

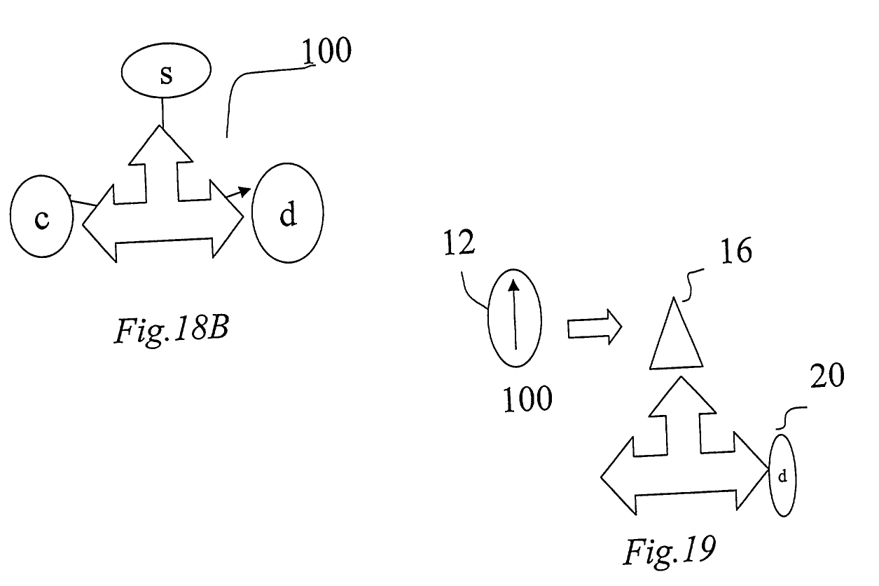

An OSPU unit in accordance with the present invention is shown in diagram form in FIGS. 18A and 18B, as three-port device taking input from a radiation source S, and distributing it along any of two other paths, designated C (short for camera) and D (for detector). Different scanning modes of the OSPU are considered in more detail in Section III.B. below.

In the above disclosure and in one preferred embodiment of the invention an OSPU is implemented using a DMA, where individual elements of the array are controlled digitally to achieve a variety of processing tasks while collecting data. In accordance with the present invention, information bearing radiation sources could be, for example, a stream of photons, a photonic wavefront, a sound wave signal, an electrical signal, a signal propagating via an electric field or a magnetic field, a stream of particles, or a digital signal. Example of devices that can act as a synapse include spatial light modulators, such as LCDs, MEMS mirror arrays, or MEMS shutter arrays; optical switches; optical add-drop multiplexers; optical routers; and similar devices configured to modulate, switch or route signals. Clearly, DMAs and other optical routing devices, as used by the optical communication industry can be used to this end. It should be apparent that liquid crystal displays (LCD), charge coupled devices (CCD), CMOS logic, arrays of microphones, acoustic transducers, or antenna elements for electromagnetic radiation and other elements with similar functionality that will be developed in the future, can also be driven by similar methods.

Applicants' contribution in this regard is in the novel process of performing pre-transduction digital computing on analog data via adaptive binning means. Such novelty can be performed in a large number of ways. For example, one can implement adaptive current addition using a parallel/serial switch and wire networks in CMOS circuits. Further, in the acoustic processing domain, one or more microphones can be used in combination with an array of adjustable tilting sound reflectors (like a DMD for sound). In each case, one can “bin” data prior to transduction, in an adaptive way, and hence measure some desired computational result that would traditionally be obtained by gathering a “data cube” of data, and subsequently digitally processing the data. The shift of paradigm is clear: in the prior art traditionally analog signals are captured by a sensor, digitized, stored in a computer as a “data cube”, and then processed. Considerable storage space and computational requirements are extended to do this processing. In accordance with the present invention, data from one or more sensors is processed directly in the analogue domain, the processed result is digitized and sent to a computer, where the desired processing result may be available directly, or following reduced set of processing operations.

In accordance with the present invention, the digitally controlled array is used as a hybrid computer, which through the digital control of the array elements performs (analog) computation of inner products or more generally of various correlations between data points reaching the elements of the array and prescribed patterns. The digital control at a given point (i.e., element) of the array may be achieved through a variety of different mechanisms, such as applying voltage differences between the row and column intersecting at the element; the modulation is achieved by addressing each row and column of the array by an appropriately modulated voltage pattern. For example, when using DMA, the mirrors are fluctuating between two tilted positions, and modulation is achieved through the mirror controls, as known in the art. The specifics of providing to the array element of signal(s) following a predetermined pattern will depend on the design implementation of the array and are not considered in further detail. Broadly, the OSPU array is processing raw data to extract desired information.

In accordance with the present invention, various assemblies of OSPU along with other components can be used to generalize the ideas presented above and enable new processing modalities. For example, FIG. 19 illustrates in block diagram form the design of a spectrograph using OSPU. As shown, the basic design brings reflected or transmitted radiation from a line in the sample or source onto a dispersing device 16, such as a grating or prism, onto the imaging fiber into the OSPU to encode and then forward to a detector 20.

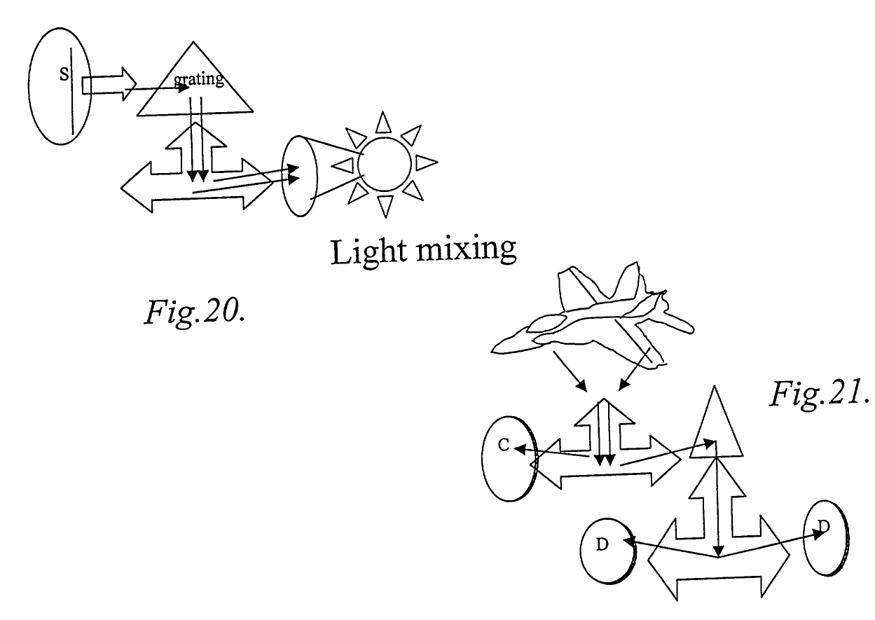

FIG. 20 illustrates in a diagram form an embodiment of a tunable light source, which operates as the spectrograph in FIG. 19, but uses a broadband source. In this case, the switching elements of the OSPU array, for example the mirrors in a DMA, are set to provide a specified energy in each row of the mirror, which is sent to one of the outgoing imaging fiber bundles. This device can also function as a spectrograph through the other end, i.e., fiber bundle providing illumination, as well as spectroscopy.

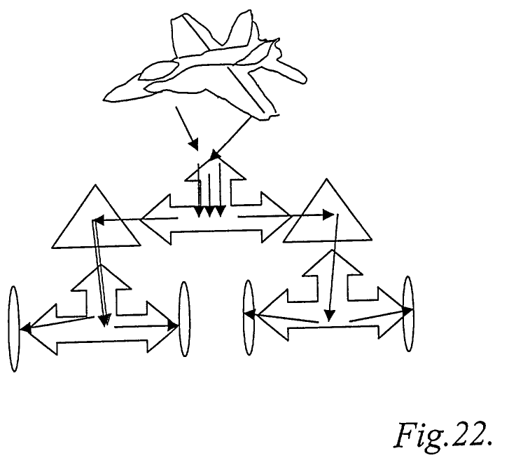

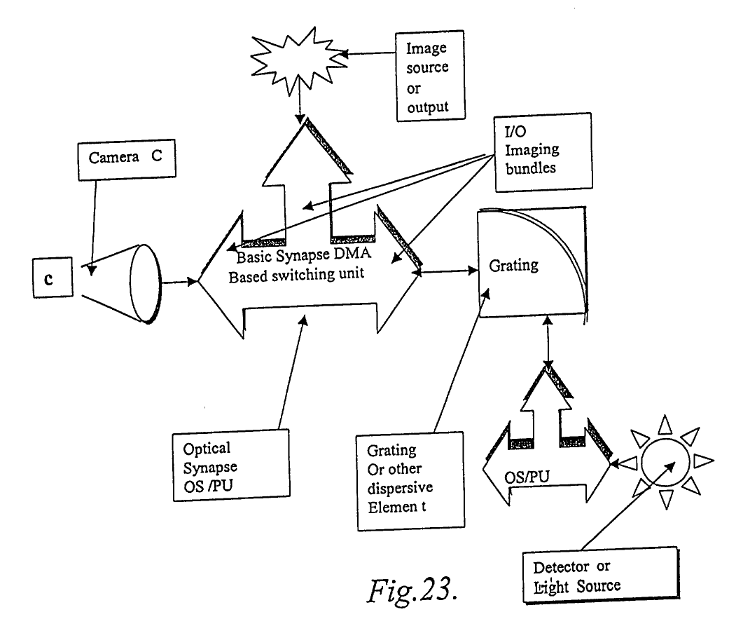

FIG. 21 illustrates in a diagram form an embodiment of the spectral imaging device discussed in Section I above, which is built with two OSPUs. Different configurations of generalized processing devices are illustrated in FIG. 22, in which each side is imaging in a different spectral band, and FIG. 23, which illustrates the main components of a system for processing input radiation using an OSPU.

B. Scanning an Area of Interest

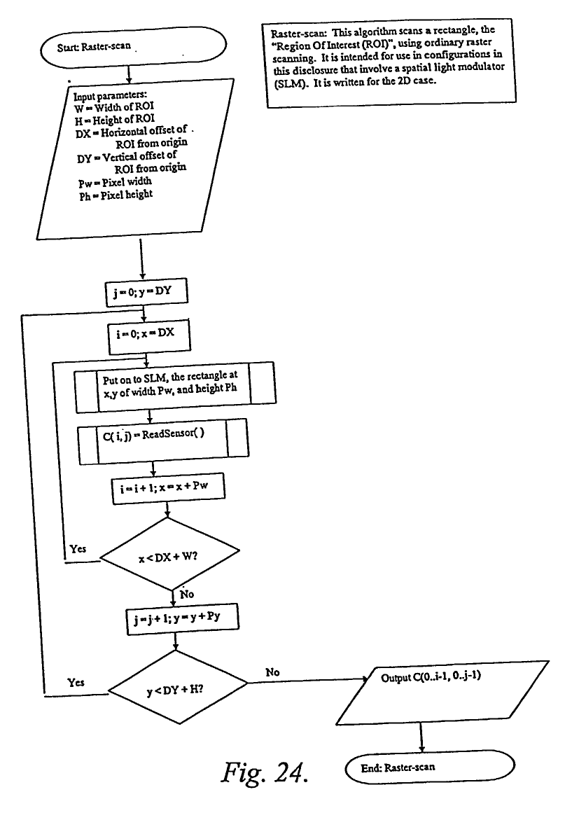

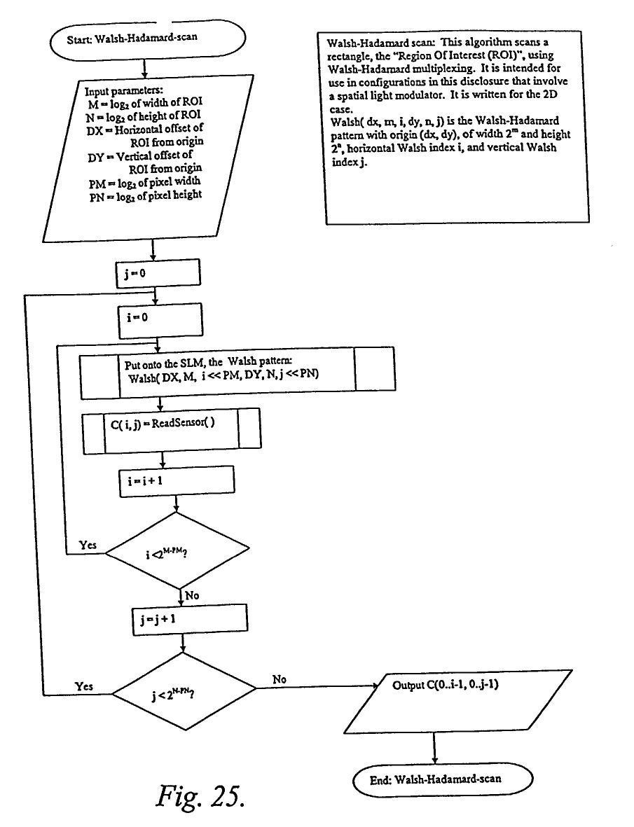

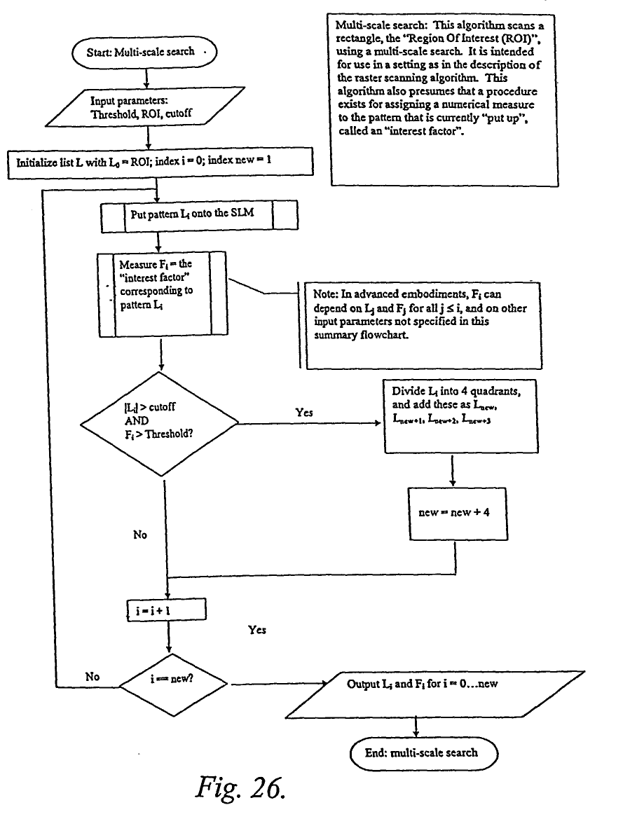

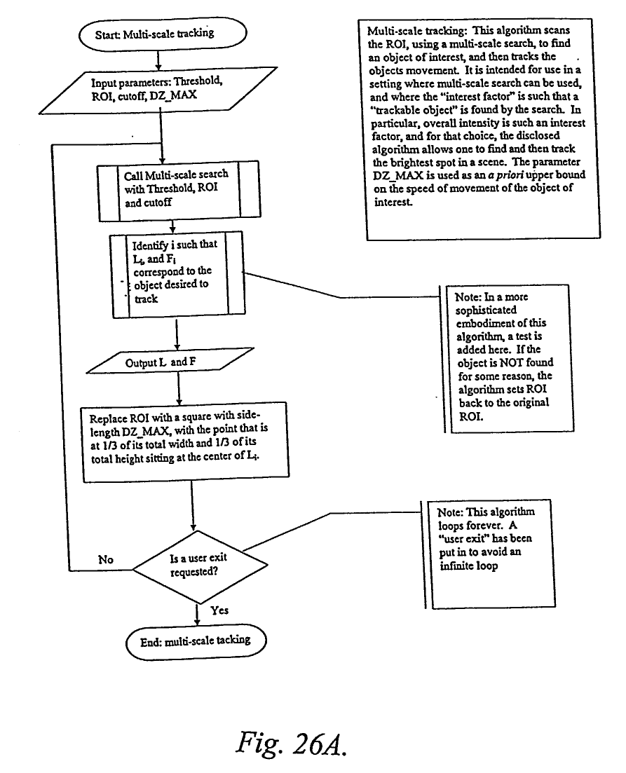

In accordance with the present invention, different scanning modes can be used in different applications, as illustrated in FIG. 24, FIG. 25 and FIG. 26. These algorithms are of use, for example, when one is using an OSPU in conjunction with a single sensor, and the OSPU is binning energy into that sensor, the binning being determined by the pattern that is put onto the SLM of the OSPU.

In particular, FIG. 24 is a flow chart of a raster-scan using in one embodiment of the present invention. This algorithm scans a rectangle, the “Region Of Interest (ROI),” using ordinary raster scanning. It is intended for use in configurations in this disclosure that involve a spatial light modulator (SLM). It is written for the 2D case, but the obvious modifications will extend the algorithm to other dimensions, or restrict to 1D.

FIG. 25 is a flowchart of a Walsh-Hadamard scan used in accordance with another embodiment of the invention. This algorithm scans a rectangle, the “Region Of Interest (ROI)”, using Walsh-Hadamard multiplexing. Walsh(dx, m, i, dy, n, j) is the Walsh-Hadamard pattern with origin (dx, dy), of width 2^{m} and height 2ⁿ, horizontal Walsh index i, and vertical Walsh index j.

FIG. 26 is a flowchart of a multi-scale scan. This algorithm scans a rectangle, the “Region Of Interest (ROI)”, using a multi-scale search. It is intended for use in a setting as in the description of the raster scanning algorithm. The algorithm also presumes that a procedure exists for assigning a numerical measure to the pattern that is currently on is called an “interest factor.”

FIG. 26A illustrates a multi-scale tracking algorithm in a preferred embodiment of the present invention. The algorithm scans the region of interest, (using multi-scan search), to find an object of interest and then tracks the object's movement across the scene. It is intended for use in a setting where multi-scale search can be used, and where the “interest factor” is such that a trackable object can be found. Examples of interest factors used in accordance with a preferred embodiment (when pattern L₁ is put onto the SLM, the sensor reads C₁ and we are defining the “interest factor” F₁). In the preceding scan algorithms a single sensor is assumed. Thus

1. F(L₁)=C₁

2. F(L₁)=C₁/area(L₁)

3. F(L₁)=C₁/C_{k,} where Lₖ is the rectangle that contains Lᵢ, and that has N times the area of L₁, (for example, N=4), and which has already been scanned by the algorithm (there will always be exactly one such).

A modification of the algorithm is possible, where instead of putting up the pattern L₁, one can put up a set of a few highly oscillatory Walsh patterns fully supported on exactly L₁, and take the mean value of the sensor reading as F₁ This estimates the total variation within L₁ and will yield an algorithm that finds the edges within a scene. In different examples the sensor is a spectrometer. F(L₁)=distance between the spectrum read by the sensor, and the spectrum of a compound of interest. (distance could be, e.g., Euclidean distance of some other standard distance). This will cause the algorithm to zoom in on a substance of interest.

In another embodiment, F(L₁)=distance between the spectrum read by the sensor, and the spectrum already read for Lₖ, where Lₖ is the rectangle that contains L₁, and that has N (N=4) times the area of L₁, and which has already bee scanned by the algorithm (there will always be exactly one such). This will cause the algorithm to zoom in on edges between distinct substances.

In yet another embodiment, F(Lₗ)=distance between the spectrum read by the sensor, and the spectrum already read for L₀. This will cause the algorithm to zoom in on substances that are anomalous compared to the background.

In derived embodiments, F(L₁) can depend on a priori data from spectral or spatio-spectral libraries.

By defining the interest factor appropriately, one can thus cover a range of different applications. In a preferred embodiment, the interest factor definitions can be pre-stored so a user can analyze a set of data using different interest factors.

It is also clear that, in the case of Walsh functions, because of the multi-scale nature of the Walsh patterns, one can combine raster and Walsh-Hadamard scanning (raster scanning at large scales, and using Walsh-Hadamard to get extra signal to noise ratio at fine scales, where it is needed most). This allows one to operate within the linear range of the detector.

Also, one can used the combined raster/Walsh idea in variations of the Multi-scale search and tracking algorithms. For this, whenever one is studying the values of a sensor associated with the sub-rectangles of a bigger rectangle, one could use the Walsh patterns at the relevant scale, instead of scanning the pixels at that scale. This will provide for an improvement in SNR. One could again do this only at finer scales, to stay in the detectors linearity range.

C. Hadamard and Generalized Hyperspectral Processing

Several signal processing tasks, such as filtering, signal enhancement, feature extraction, data compression and others can be implemented efficiently by using the basic ideas underlying the present invention. The concept is first illustrated in the context of one-dimensional arrays for Hadamard spectroscopy and is then extended to hyperspectral imaging and various active illumination modes. The interested reader is directed to the book “Hadamard Transform Optics” by Martin Harwit, et al., published by Academic Press in 1979, which provides an excellent overview of the applied mathematical theory and the degree to which common optical components can be used in Hadamard spectroscopy and imaging applications.

Hadamard processing refers generally to analysis tools in which a signal is processed by correlating it with strings of 0 and 1 (or +/−1). Such processing does not require the signal to be converted from analogue to digital, but permits direct processing on the analog data by means of an array of switches (synapse). In a preferred embodiment of the invention, an array of switches, such as a DMA, is used to provide spatio-spectral tags to different radiation components. In alternative embodiments it can also be used to impinge spatio/spectral signatures, which directly correlate to desired features.

A simple way to explain Hadamard spectroscopy is to consider the example of the weighing schemes for a chemical scale. Assume that we need to weigh eight objects, x₁, x₂ . . . x₈ on a scale. One could weigh each object separately in a process analogous to performing a raster scan, or balance two groups of four objects. Selecting the second approach, assuming that the first four objects are in one group, and the second four in a second group, balancing the two groups can be represented mathematically using the expression:

m=x₁+x₂+x₃+x₄−(x₅+x₆+x₇+x₈)=(x, w),

where x is a vector, the components of which correspond to the ordered objects xi,=(1, 1, 1, 1, −1, −1, −1, −1) and (x, w) designates the inner product of the two vectors. Various other combinations of object groups can be obtained and mathematically expressed as the inner product of the vector x and a vector of weights w, which has four +1 and four −1 elements.

For example, w=(1, −1, 1, 1, −1, −1, 1,−1) indicates that x₁, x₃, x₄, x₇ are on the left scale while x₂ x₅ x₆ x₈ are on the right. The inner product, or weight M=(x, w) is given by the expression:

m=(x, w)=x₁−x₂+x₃+x₄−x₅−x₆+x₇−x₈

It is well known that if one picks eight mutually orthogonal vectors w₁ which correspond, for example, to the eight Walsh patterns, one can recover the weight xof each object via the orthogonal expansion method

x=[(x, w₁)w₁+(x, w₂)w₂+ . . . +(x, w₈)w₈],

or in matrix notation

[W]x=m; x=[W]⁻¹m

where [W] is the matrix of orthogonal vectors, m is the vector of measurements, and [W]⁻¹ is the inverse of matrix [W].

It is well known that the advantage of using the method is its higher-accuracy, more precisely if the error for weighing measurement is ε, the expected error for the result calculated from the combined measurements is reduced by the square root of the number of samples. This result was proved by Hotteling to provide the best reduction possible for a given number of measurements.

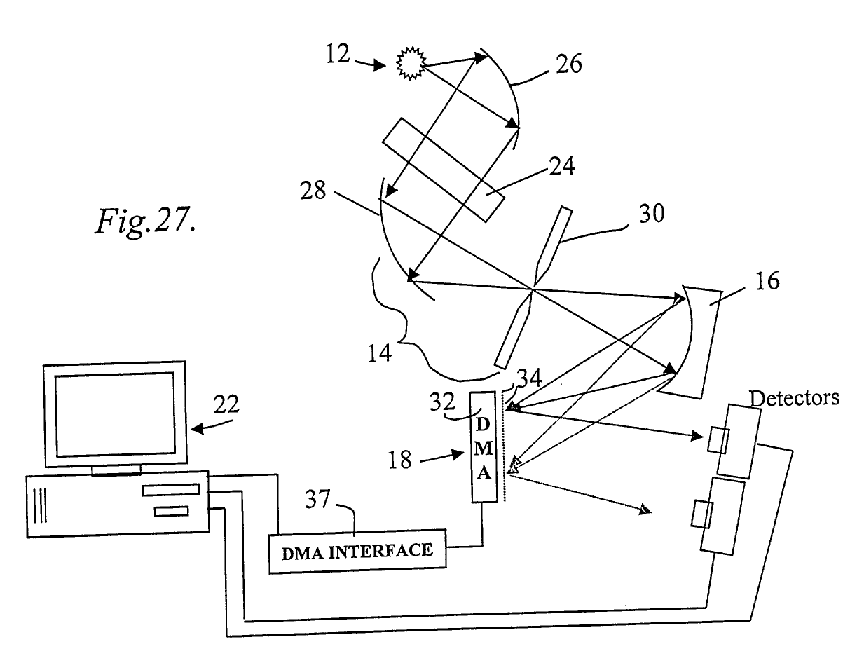

In accordance with the present invention, this signal processing technique finds simple and effective practical application in spectroscopy, if we consider a spectrometer with two detectors (replacing the two arms of the scales). With reference to FIG. 27, the diffraction grating sends different spectral lines into an eight mirror array, which redistributes the energy to the 2 detectors in accordance with a given pattern of +1/−1 weights, i.e., wᵢ=(1, −1, 1, 1, −1, −1, 1, −1). Following the above analogy, the difference between the output values of the detectors corresponds to the inner product m=(x, wᵢ). If one is to redistribute the input spectrum energy to the 2 spectrometers using eight orthogonal vectors of weights, (following the pattern by alternating the mirror patterns to get eight orthogonal configurations), an accurate measurement of the source spectrum can be obtained. This processing method has certain advantages to the raster scan in which the detector measures one band at a time.

Clearly, for practical applications a precision requiring hundreds of bands may be required to obtain accurate chemical discrimination. However, it should be apparent that if one knows in advance which bands are needed to discriminate two compounds, the turning of the mirrors to only detect these bands could provide such discrimination with a single measurement.

Following is a description of a method for selecting efficient mirror settings to achieve discrimination using a minimum number of measurements. In matrix terminology, the task is to determine a minimum set of orthogonal vectors.

In accordance with the present invention, to this end one can use the Walsh-Hadamard Wavelet packets library. As known, these are rich collections of ±1, 0 patterns which will be used as elementary analysis patterns for discrimination. They are generated recursively as follows: (a) first, double the size of the pattern w in two ways either as (w, w) or as (w, −w). It is clear that if various n patterns wi of length n are orthogonal, then the 2n patterns of length 2n are also orthogonal. This is the simplest way to generate Hadamard-Walsh matrices.

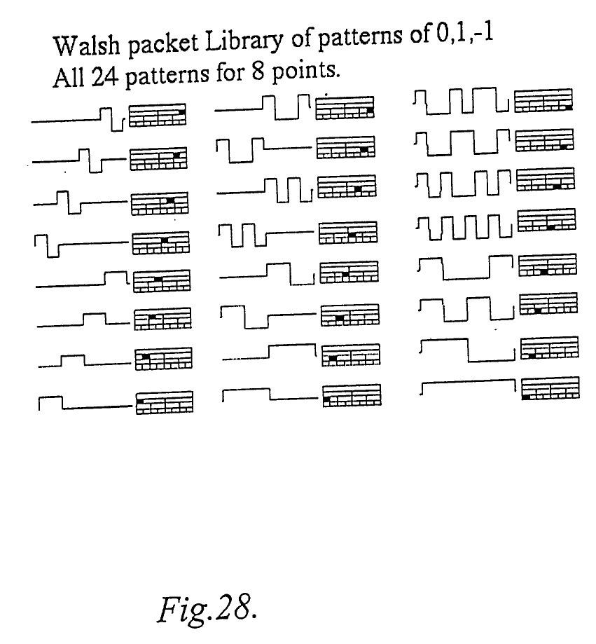

The wavelet packet library consists of all sequences of length N having broken up in 2^{m} blocks, all except one are 0 and one block is filled with a Walsh pattern (of ±1) of length 2^{l} where l+m=n. As known, a Walsh packet is a localized Walsh string of ±1. FIG. 28 illustrates all 24 library elements for N=8.

A correlation of a vector x with a Walsh packet measures a variability of x at the location where the packet oscillates. The Walsh packet library is a simple and computationally efficient analytic tool allowing sophisticated discrimination with simple binary operations. It can be noted that in fact, it is precisely the analog of the windowed Fourier transform for binary arithmetic.

As an illustration, imagine two compounds A and B with subtle differences in their spectrum. The task is to discriminate among them in a noisy environment and design efficient mirror configurations for DMA spectroscope. In accordance with a preferred embodiment, the following procedure can be used:

(1) Collect samples for both A and B, the number of samples collected should be representative of the inherent variability of the measurements. A sample in this context is a full set x of the spectrum of the compound.

(2) Compute the inner product (x, w) for all samples X of A and (y, w) for all samples Y of B for each fixed Walsh product w.

(3) Measure the discrimination power pw of the pattern w to distinguish between compound A and B. This could be done by comparing the distribution of the numbers {(x·w)} to the distribution of the numbers {(y, w)}, where the farther apart these distributions, the better they can be distinguished.

(4) Select an orthogonal basis of patterns w maximizing the total discrimination power and order them in decreasing order.

(5) Pick the top few patterns as an input to a multidimensional discrimination method.

As an additional optional step in the above procedure, experiments can be run using data on which to top few selected patterns failed, and repeat steps 3, 4 and 5.

Because of the recursive structure of the W-packet library, it is possible to achieve 2+3+4 in Nlog2 N computations per sample vector of length N, i.e. essentially at the rate data collection. It should be noted that this procedure of basis selection for discrimination can also be used to enhance a variety of other signal processing tasks, such as data compression, empirical regression and prediction, adaptive filter design and others. It allows to define a simple orthogonal transform into more useful representations of the raw data. Further examples are considered below and illustrated in Section IV in the wheat protein example.

In this Section we considered the use of Hadamard processing to provide simple, computationally efficient and robust signal processing. In accordance with the present invention, the concept of using multiple sensors and/or detectors can be generalized to what is known as hyperspectral processing.

As known, current spectroscopic devices can be defined broadly into two categories—point spectroscopy and hyperspectral imaging. Point spectroscopy in general involves a single sensor measuring the electromagnetic spectrum of a single sample (spatial point). This measurement is repeated to provide a point-by-point scan of a scene of interest. In contrast, hyperspectral imaging generally uses an array of sensors and associated detectors. Each sensor corresponds to the pixel locations of an image and measures a multitude of spectral bands. The objective of this imaging is to obtain a sequence of images, one for each spectral band. At present, true hyperspectral imaging devices, having the ability to collect and process the full combination of spectral and spatial data are not really practical as they require significant storage space and computational power.

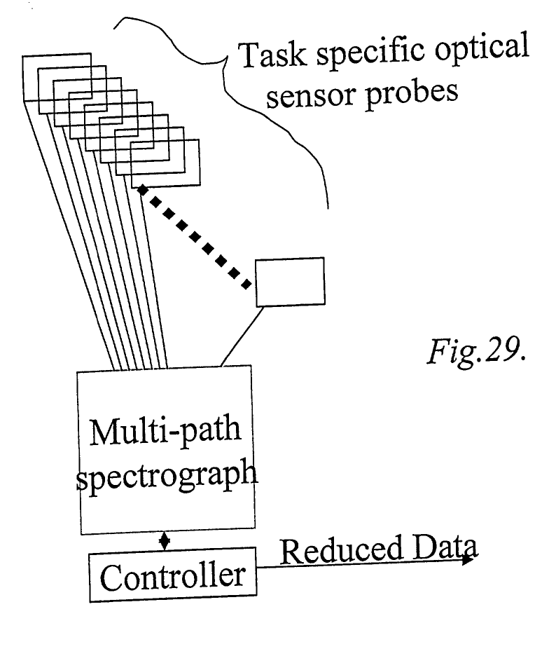

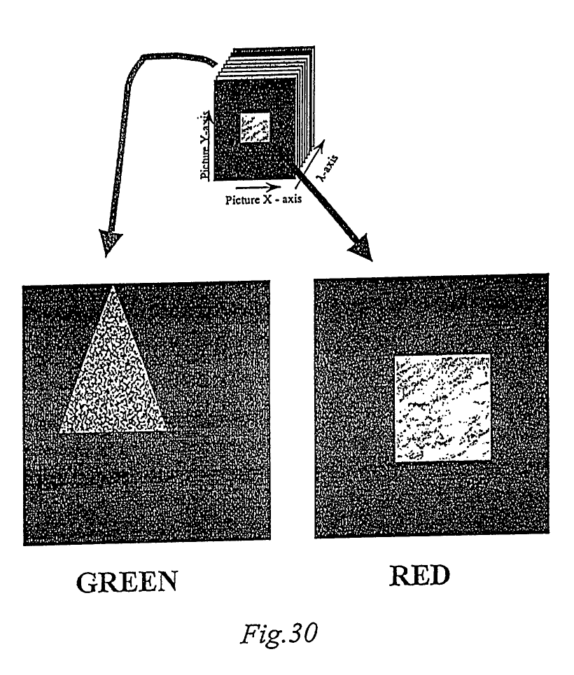

In accordance with the present invention, significant improvement over the prior art can be achieved using hyperspectral processing that focuses of predefined characteristics of the data. For example, in many cases only a few particular spectral lines or bands out of the whole data space are required to discriminate one substance over another. It is also often the case that target samples do not posses very strong or sharp spectral lines, so it may not be necessary to use strong or sharp bands in the detection process. A selection of relatively broad bands may be sufficient do discriminate between the target object and the background. It should be apparent that the ease with which different spatio-spectral bands can be selected and processed in accordance with the present invention is ideally suited for such hyperspectrum applications. A generalized block diagram of hyperspectral processing in accordance with the invention is shown in FIG. 29. FIG. 30 illustrates two spectral components (red and green) of a data cube produced by imaging the same object in different spectral bands. It is quite clear that different images contain completely different kinds of information about the object.

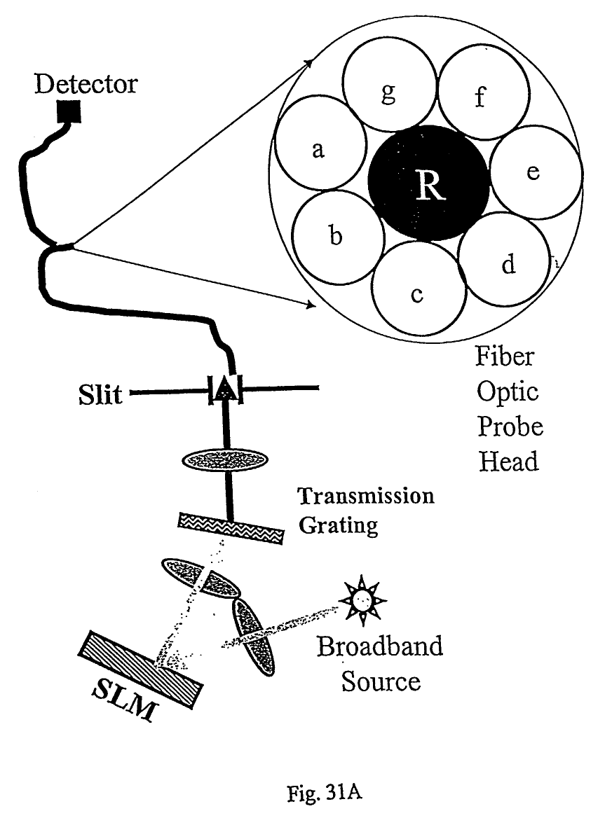

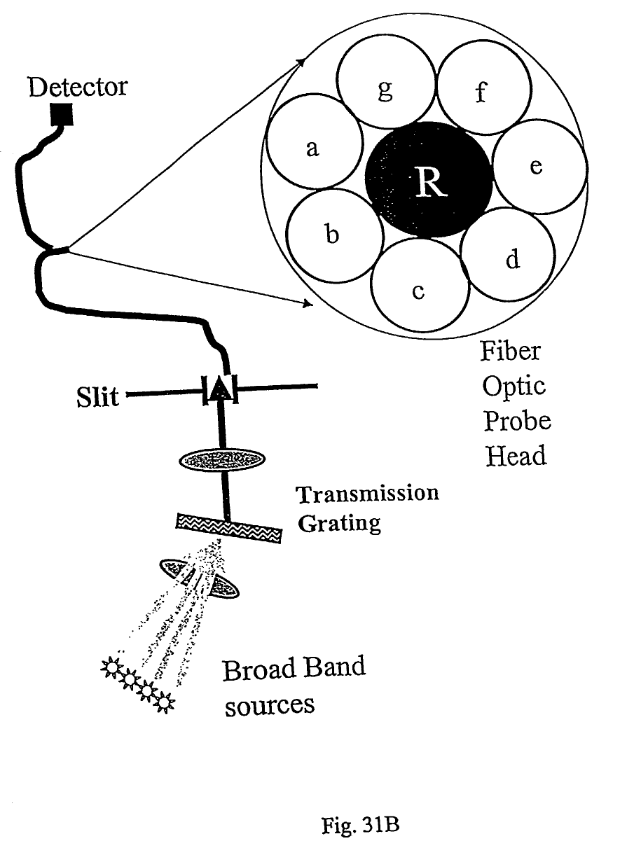

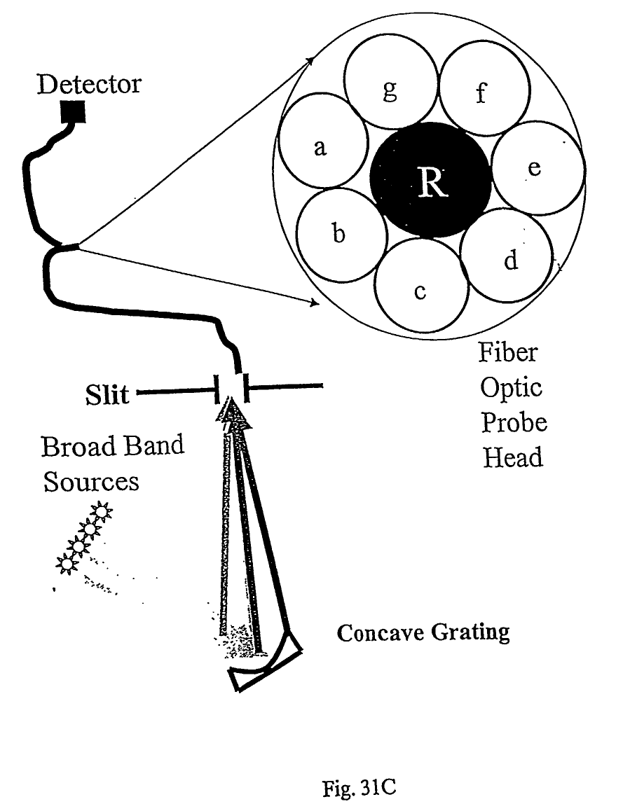

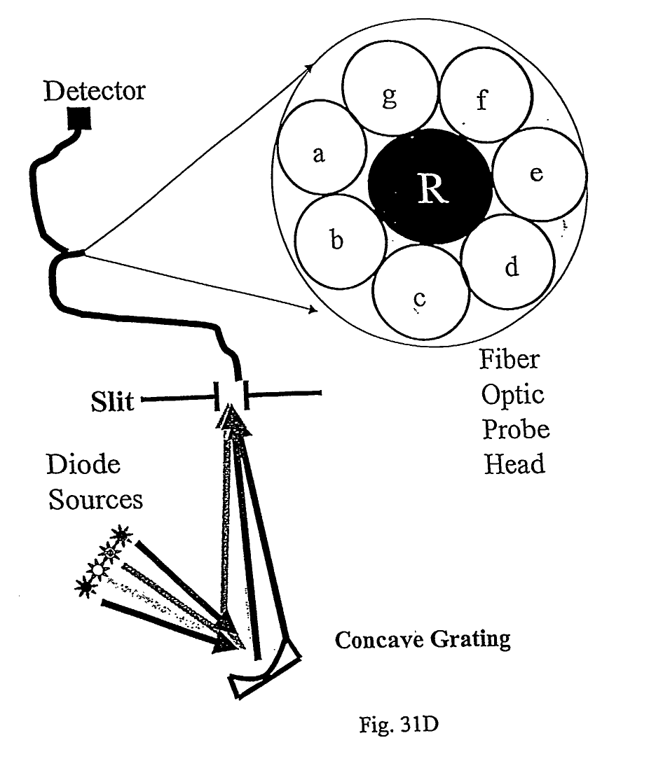

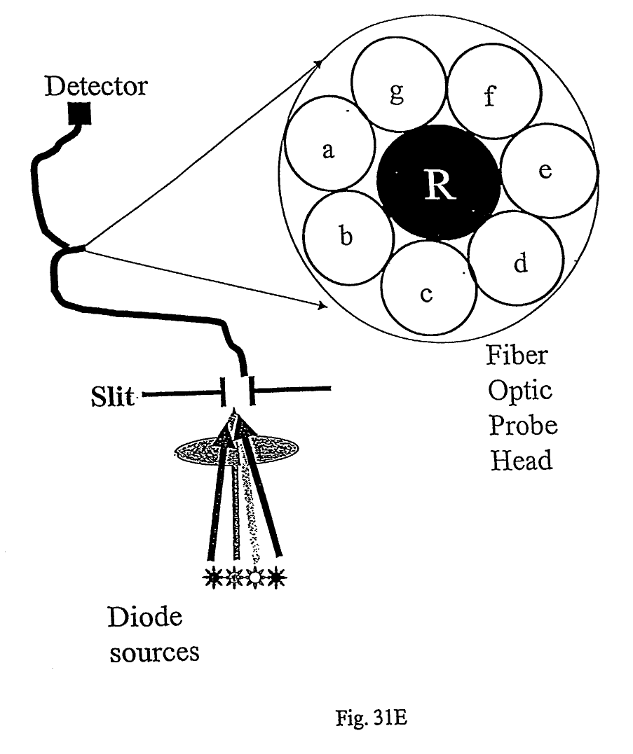

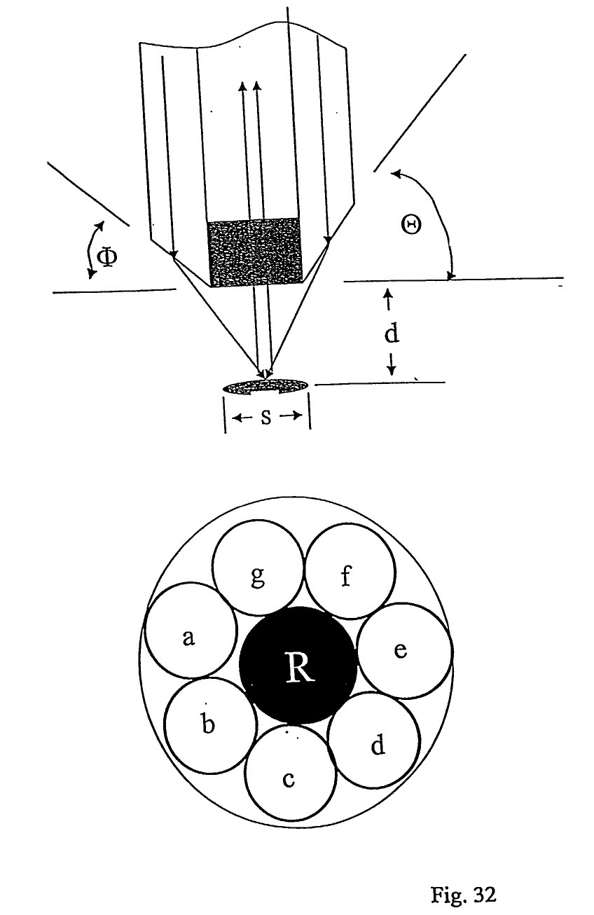

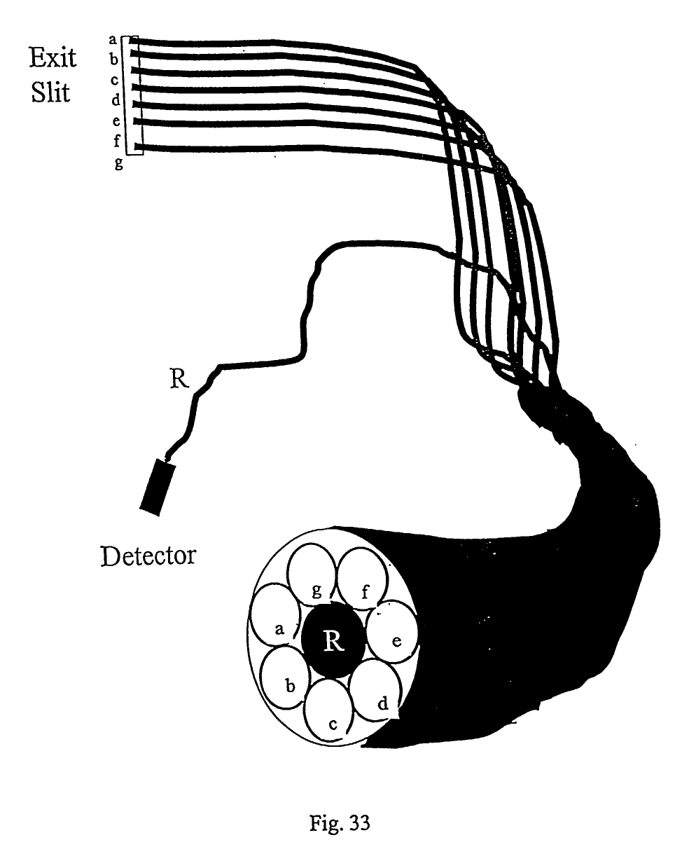

FIGS. 31A-E illustrate different embodiments of an imaging spectrograph in de-dispersive mode, that can be used in accordance with this invention for hyperspectral imaging in the UV, visual, near infrared and infrared portions of the spectrum. For illustration purposes, the figures show a fiber optic probe head with a fixed number of optical fibers. As shown, the fiber optic is placed at an exit slit. It will be apparent that a multitude of fiber optic elements and detectors can be used in alternate embodiments.

FIG. 32 shows an axial and cross-sectional view of the fiber optic assembly illustrated in FIGS. 31A-E.

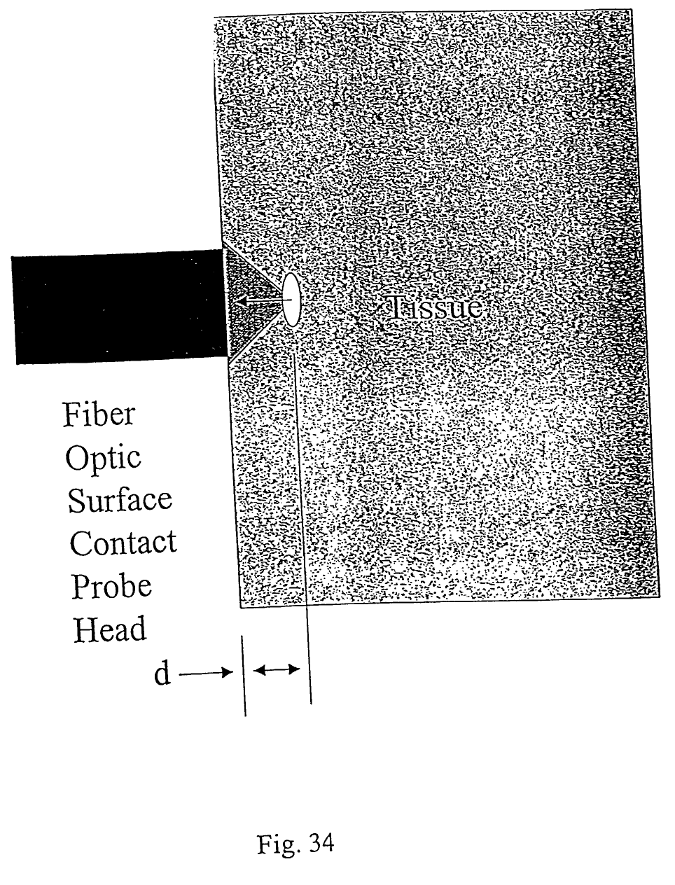

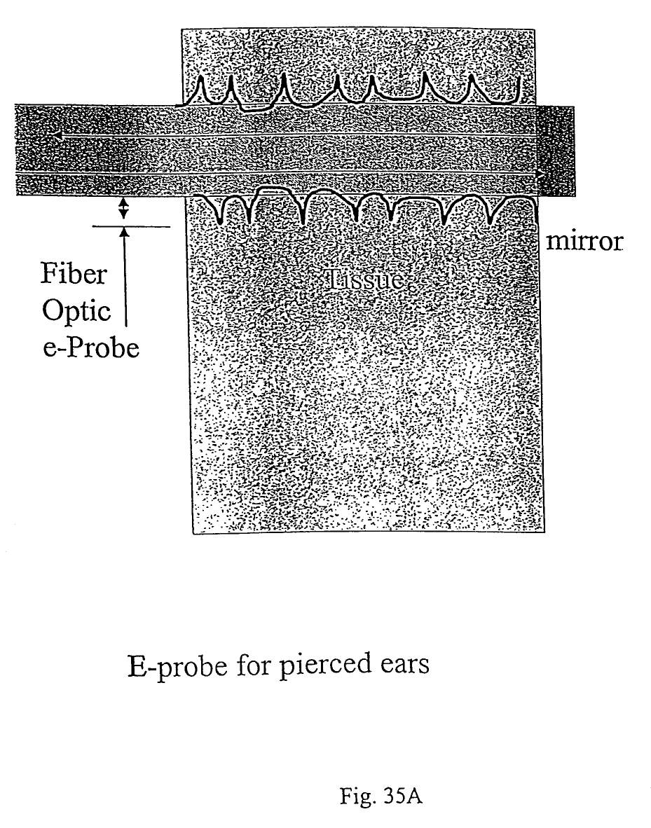

FIG. 33 shows a physical arrangement of the fiber optic cable, detector and the slit. FIG. 34 illustrates a fiber optic surface contact probe head abutting tissue to be examined;

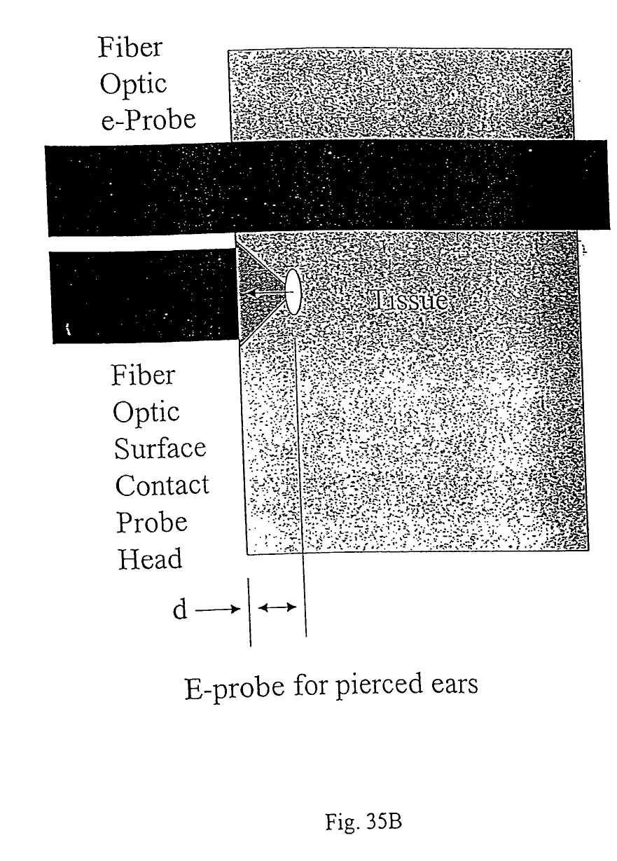

FIGS. 35A and 35B illustrate a fiber optic e-Probe for pierced ears that can be used for medical monitoring applications in accordance with the present invention.

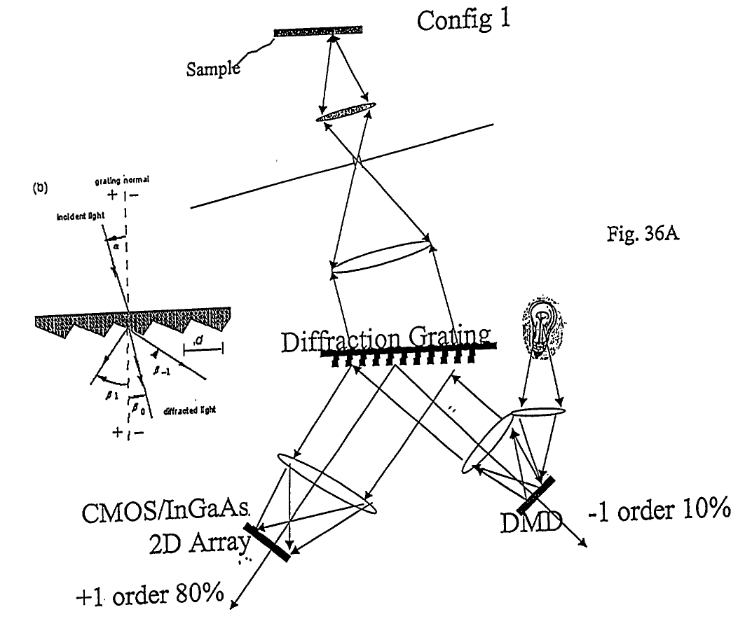

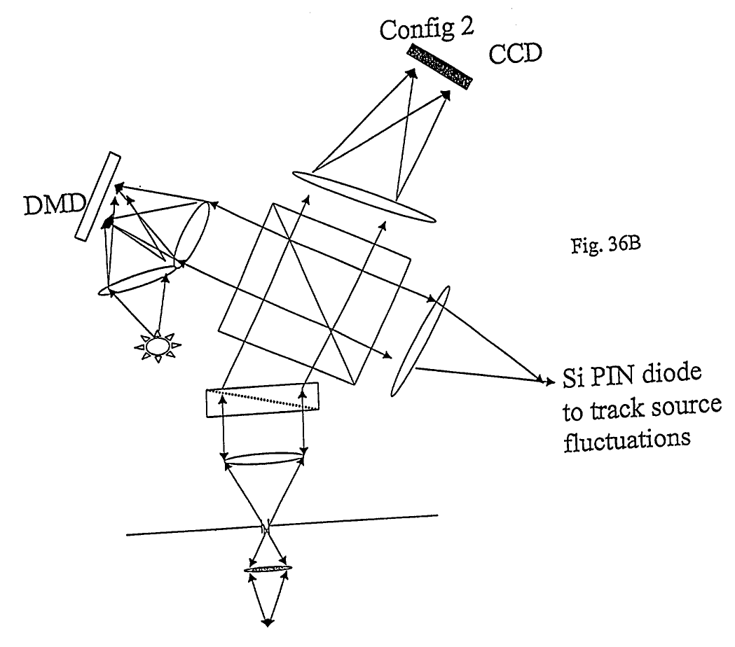

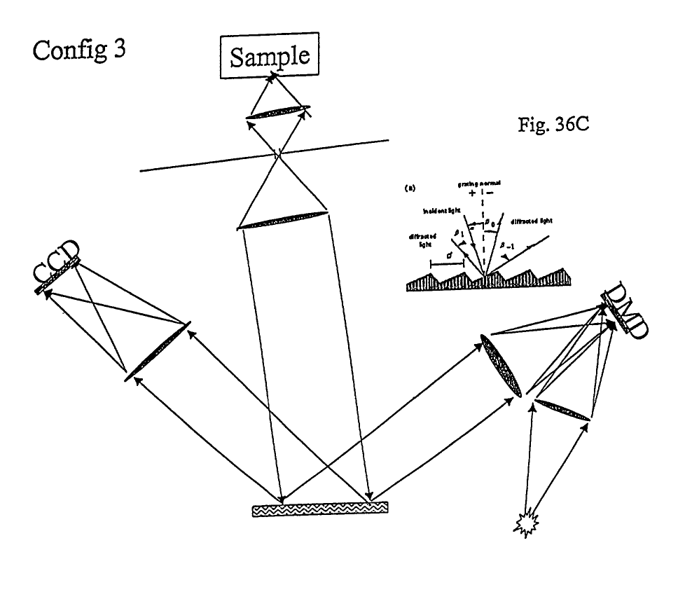

FIGS. 36A, 36B and 36C illustrate different configurations of a hyperspectral adaptive wavelength advanced illuminating imaging spectrograph (HAWAIIS).

In FIG. 36A, DMD (shown illuminating the −1 order) is a programmable spatial light modulator that is used to select spatio/spectral components falling upon and projecting from the combined entrance/exit slit. The illumination is fully programmable and can be modulated by any contiguous or non-contiguous combination at up to 50 KHz. The corresponding spatial resolution element located at the Object/sample is thus illuminated and is simultaneously spectrally imaged by the CCD (located in order +1 with efficiency at 80%) as in typical CCD imaging spectrographs used for Raman spectral imaging.

With reference to FIG. 36, the output of a broadband light source such as a TQH light bulb(1001) is collected by a collection optic (lens 1002) and directed to a spatial light modulator such as the DMA used in this example(1003). Specific spatial resolution elements are selected by computer controlled DMA driver to propogate to the transmission diffraction grating (1005) via optic (lens 1004). The DMA(1003) shown illuminating the −1 order of the transmission diffraction grating (1005) is a programmable spatial light modulator that is used to select spatio/spectral resolution elements projecting through the entrance/exit slit (1007) collected and focused upon the sample (1009) by optic lens (1008). The spatio/spectral resolution elements illuminating the sample are fully programmable. The sample is thus illuminated with specific and known spectral resolution elements. The reflected spectral resolution elements from specific spatial coordinates at the sample plane are then collected and focused back through the entrance/exit slit by optic (lens 1008). Optic (lens 1006) collimates the returned energy and presents it to the transmission diffraction grating (1005). The light is then diffracted preferentially into the +1 order and is subsequently collected and focused by the optic (lens 1010) onto a 2D dector array(1011). This conjugate spectral imaging device has the advantage of rejecting out of focus photons from the sample. Spectral resolution elements absorbed or reflected are measured with spatial specificity by the device.

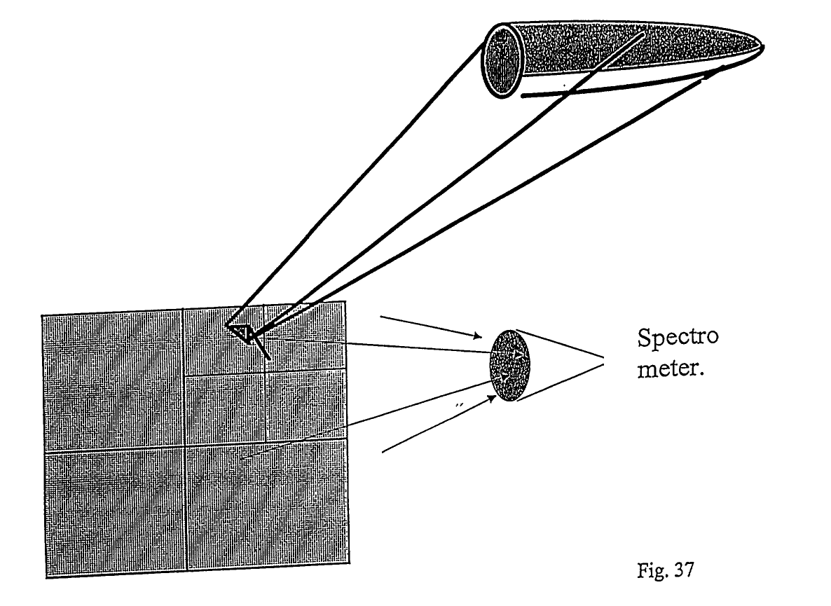

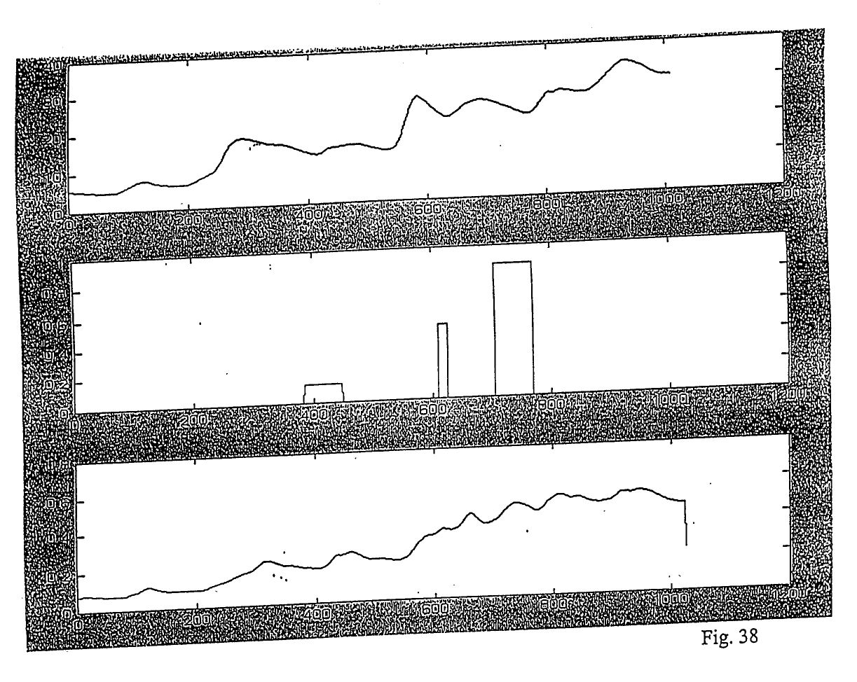

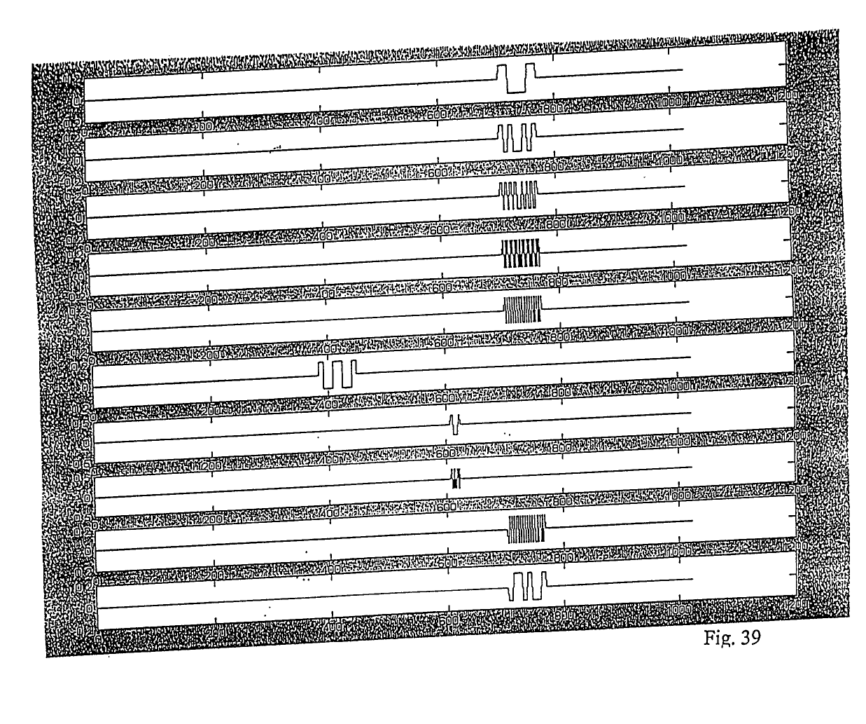

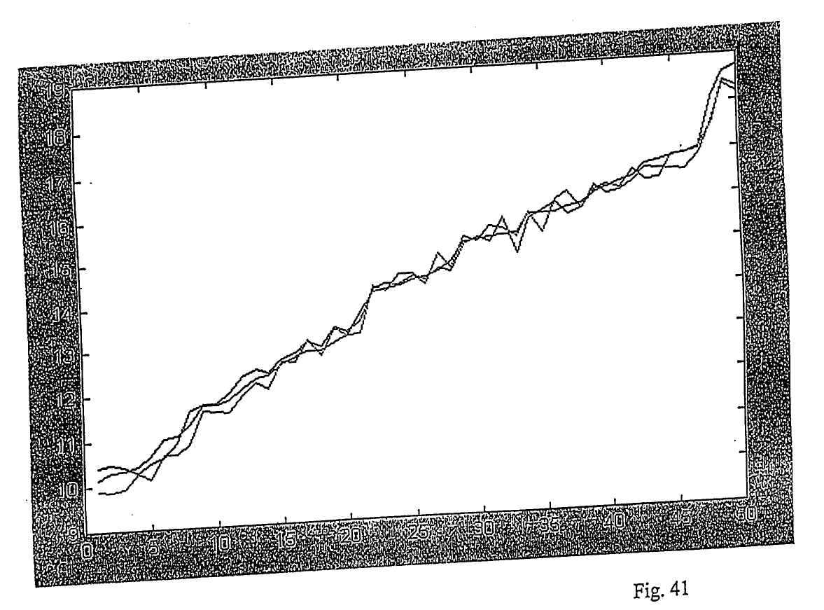

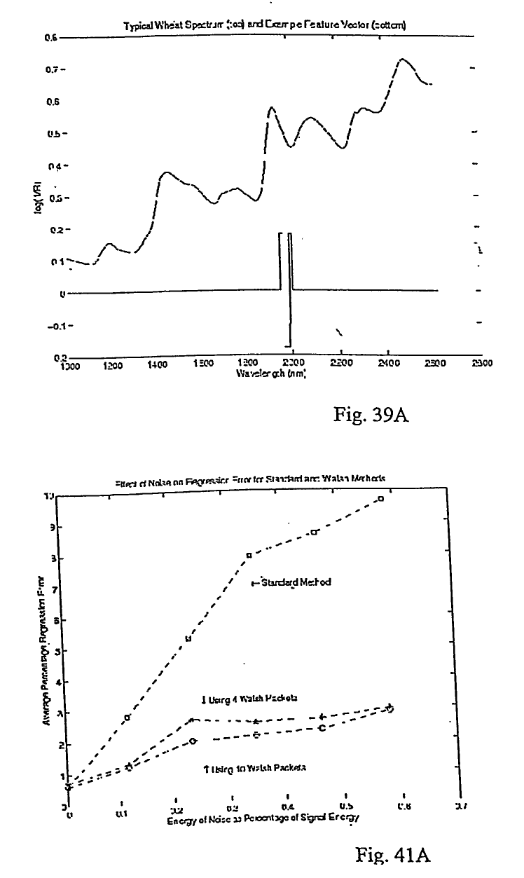

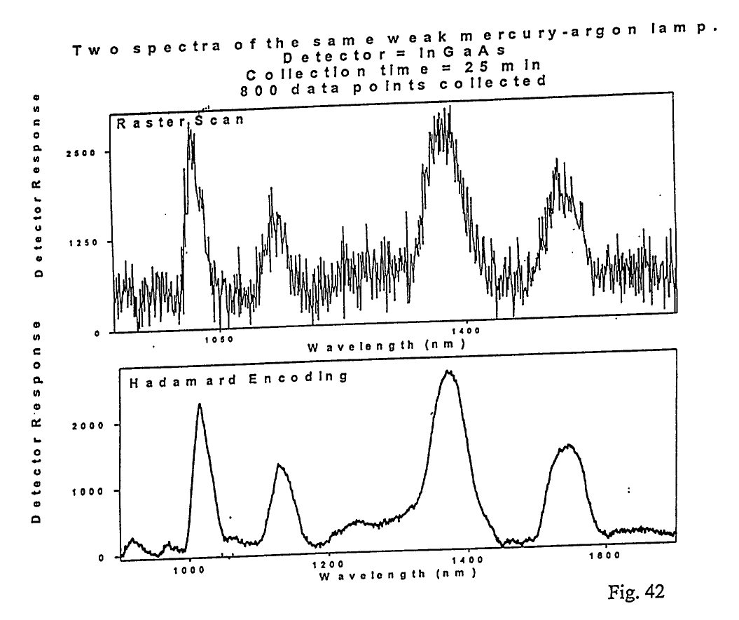

FIG. 37 illustrates a DMA search by splitting the scene to speed up the performance of the processing algorithm. FIG. 38 illustrates wheat spectra data (training) and wavelet spectrum in an example of determining protein content in wheat. FIG. 39 illustrates the top 10 wavelet packets in local regression basis selected using 50 training samples in the example of FIG. 38. FIG. 40 is a scatter plot of protein content (test data) vs. correlation with top wavelet packet. FIG. 41 illustrates PLS regression of protein content of test data. FIG. 42 illustrates the advantage of DNA-based Hadamard Spectroscopy used in accordance with the present invention over the regular raster scan.

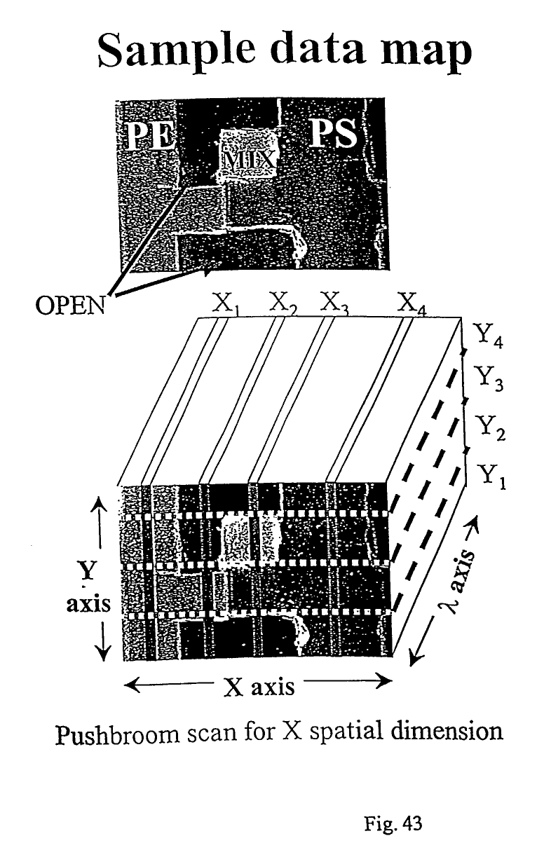

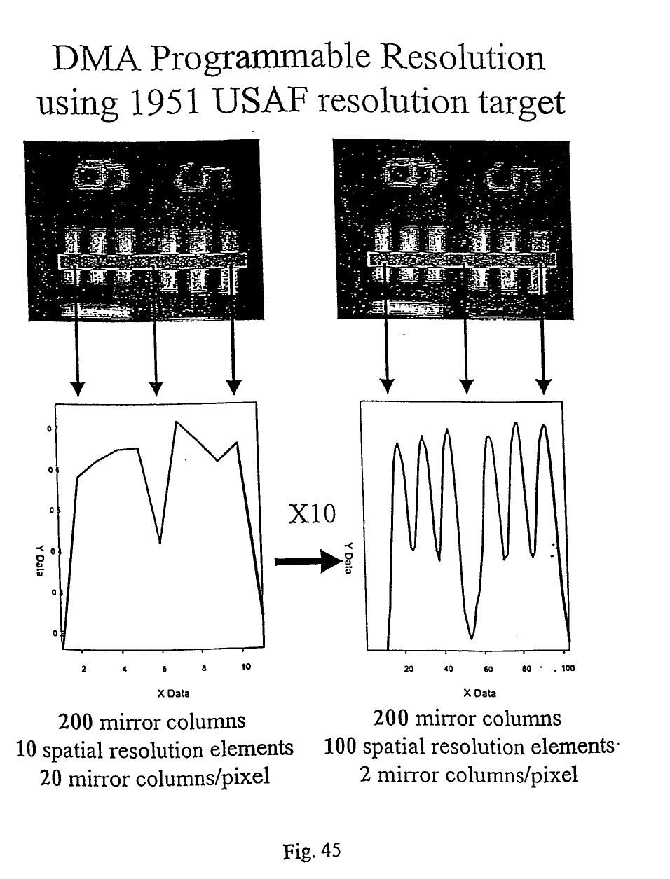

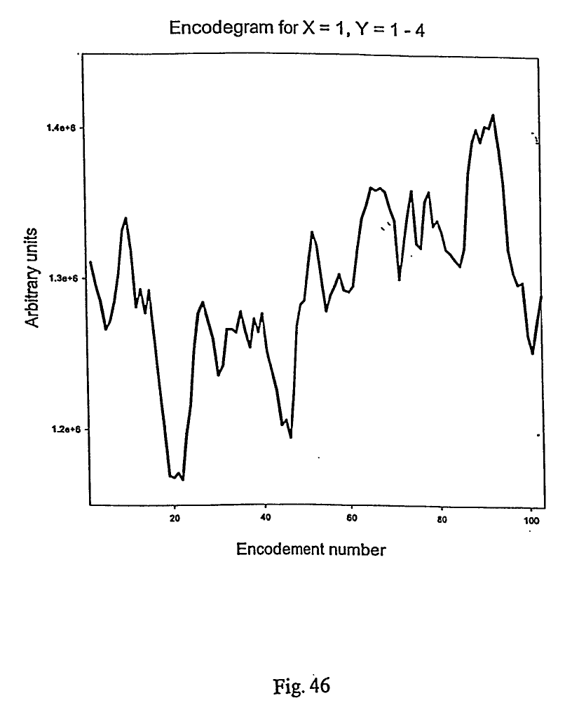

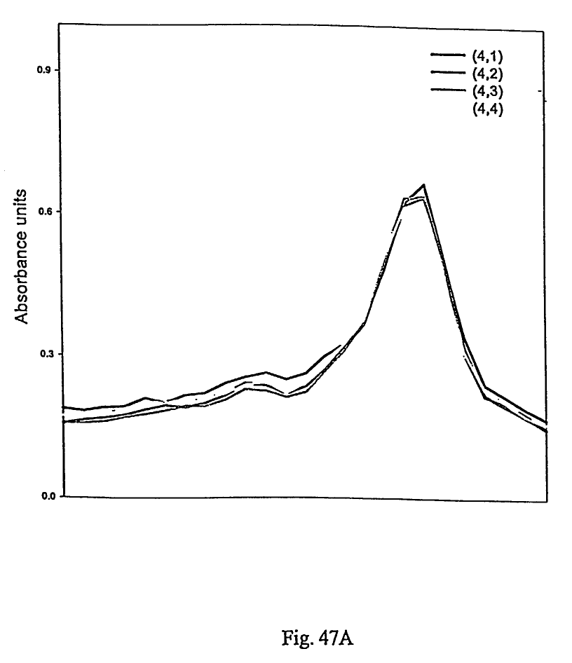

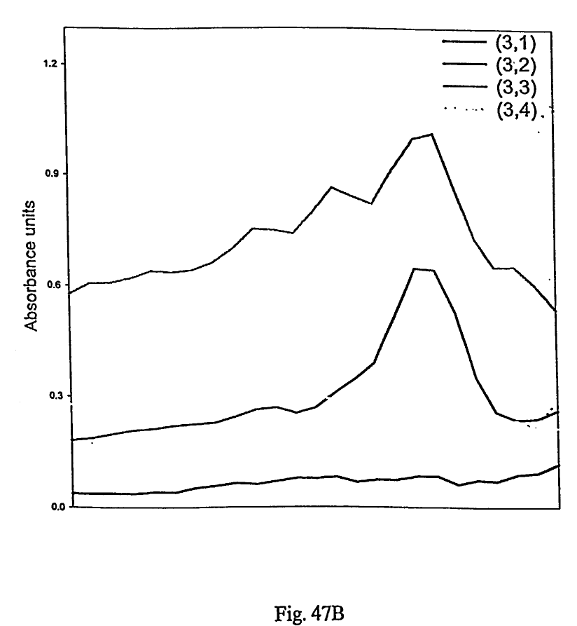

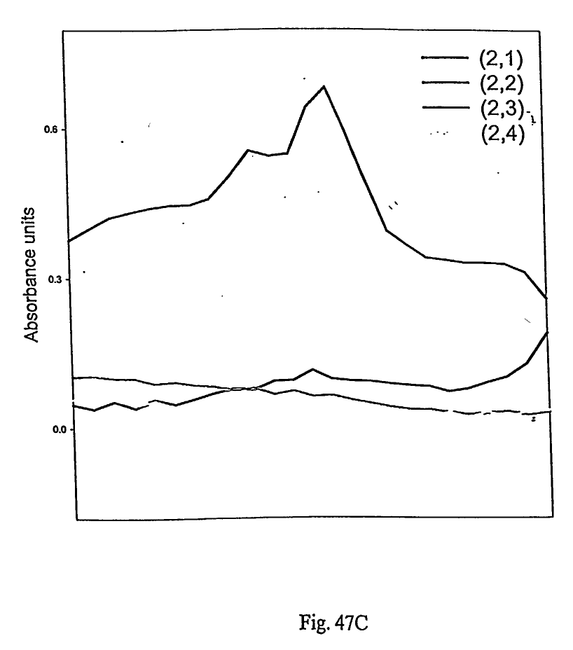

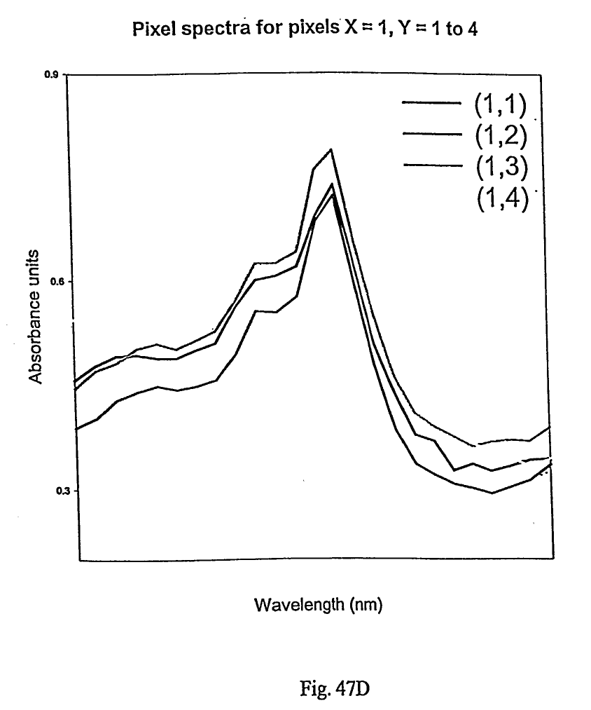

FIGS. 43-47(A-D) illustrate hyperspectrum processing in accordance with the present invention, including data maps, encodement mask, DMA programmable resolution using different numbers of mirrors and several encodegrams.

D. Spatio-Spectral Tagging

One of the most important aspects of the present invention is the use of modulation of single array elements or groups of array elements to “tag” radiation impinging on these elements with its own pattern of modulation. In essence, this aspect of the invention allows to combine data from a large number of array elements into a few processing channels, possibly a single channel, without losing the identity of the source and/or the spatial or spectral distribution of the data.

As known in the art, combination of different processing channels into a smaller number of channels is done using signal multiplexing. In accordance with the present invention, multiplexing of radiation components which have been “tagged” or in some way encoded to retain the identity of their source, is critical in various processing tasks, and in particular enables simple, robust implementations of practical devices. Thus, for example, in accordance with the principles of the present invention, using a micro mirror array, an optical router, an on-off switch (such as an LCD screen), enables simplified and robust image formation with a single detector and further makes possible increasing the resolution of a small array of sensors to any desired size, as discussed in Section IV next.

The important point in this respect is that in accordance with this invention, methods for digitally-controlled modulation of sensor arrays are used to perform signal processing tasks while collecting data. Thus, the combination and binning of a plurality of radiation sources is manipulated in accordance with this invention to perform calculations on the analog data, which is traditionally done in the digital data analysis process. As a result, a whole processing step can be eliminated by preselecting the switching modulation to perform the processing before the A/D conversion, thereby only converting data quantities of interest. This aspect of the present invention enables realtime representation of the final processed data, which in processing intense applications can be critical.

E. Data Compression, Feature Extraction and Diagnostics

By modulating the SLM array used in accordance with this invention, so as to compute inner products with elements of an orthogonal basis, the raw data can be converted directly on the sensor to provide the data in transform coordinates, such as Fourier transform, Wavelet transform, Hadamard, and others. This is in fact a key aspect of the resent invention, and the reason why it is important is that the amount of data collected is so large that it may swamp the processor or result in insufficient bandwidth for storage and transmission. As known in the art, without some compression an imaging device may become useless. As noted above, for hyperspectral imaging a full spectrum (a few hundred data points) is collected for each individual pixel resulting in a data glut. Thus, compression and feature extraction are essential to enable a meaningful image display. It will be appreciated that the resulting data file is typically much smaller, providing significant savings in both storage and processing requirements. A simple example is the block 8×8 Walsh expansion, which is automatically computed by appropriate mirror modulation, the data measured is the actual compressed parameters.

In another related aspect of the present invention, data compression can also be achieved by building an orthogonal basis of functions retaining the important features for the task at hand. In a preferred embodiment, this can be achieved by use of the best basis algorithm. See, for example, Coifman, R. R. and Wickerhauser, M. V., “Entropy-based Algorithms for Best Basis Selection”, IEEE Trans. Info. Theory 38 (1992), 713-718, and U.S. Pat. Nos. 5,526,299 and 5,384,725 to one of the inventors of this application. The referenced patents and publications are incorporated herein by reference.

By means of background, it is known that the reduction of dimensionality of a set of data vectors can be accomplished using the projection of such a set of vectors onto a orthogonal set of functions, which are localized in time and frequency. In a preferred embodiment, the projections are defined as correlation of the data vectors with the set of discretized re-scaled Walsh functions, but any set of appropriate functions can be used instead, if necessary.

The best basis algorithm to one of the co-inventors of this application provides a fast selection of an adapted representation for a signal chosen from a large library of orthonormal bases. Examples of such libraries are the local trigonometric bases and wavelet packet bases, both of which consist of waveforms localized in time and frequency. An orthonormal basis in this setting corresponds to a tiling of the time-frequency plane by rectangles of area one, but an arbitrary such tiling in general does not correspond to an orthonormal basis. Only in the case of the Haar wavelet packets is there a basis for every tiling, and a fast algorithm to find that basis is known. See, Thiele, C. and Villemoes, L., “A Fast Algorithm for Adapted Time-Frequency Tilings”, Applied and Computational Harmonic Analysis 3 (1996), 91-99, which is incorporated by reference.

Walsh packet analysis is a robust, fast, adaptable, and accurate alternative to traditional chemometric practice. Selection of features for regression via this method reduces the problems of instability inherent in standard methods, and provides a means for simultaneously optimizing and automating model calibration.

The Walsh system {Wₙ}ₙ₌₀^{∞} is defined recursively by

W₂ₙ(t)=Wₙ(2t)+(−1)ⁿWₙ(2t−1)

W₂ₙ₊₁(t)=Wₙ(2t)−(−1)ₙWₙ(2t−1)

With W₀(t)=1 on 0≦t<1. If [0,1[x[0,∞[is the time frequency plane, dyadic rectangles are subsets of the form

I×ω=[2^{-j}k,2^{-j}(k+1)[×[2^{m}n,2^{m}(n+1)[,

with j, k, m and n non-negative integers, and the tiles are the rectangles of area one (j=m). A tile p is associated with a resealed Walsh function by the expression

wₚ(t)=2^{j/2}Wₙ(2^{j}t−k)

Fact: The function wₚ and w_{q} are orthogonal if and only if the tiles p and q are disjoint. Thus, any disjoint tiling will give rise to an orthonormal basis of L²(0,1) consisting of rescaled Walsh functions. For any tiling B, we may represent a function f as

$$f = {\sum }_{p ∈ B} ⟨ f , {w}_{p} ⟩ {w}_{p}$$

and may find an optimal such representation for a given additive cost functional by choosing a tiling minimizing the cost evaluated on the expansion coefficients.

In Section IV we consider an example contrasting the use of adaptive Walsh packet methods with standard chemometrics for determining protein concentration in wheat. The data consists of two groups of wheat spectra, a calibration set with 50 samples and a validation set of 54 samples. Each individual spectrum is given in units of log(1/R) where R is the reflectance and is measured at 1011 wavelengths, uniformly spaced from 1001 nm to 2617 nm. Standard chemometric practice involves computing derivative-like quantities at some or all wavelengths and building a calibration model from this data using least squares or partial least squares regression.

To illustrate this, let Y₁ be the percent protein for the i-th calibration spectrum Sᵢ, and define the feature X₁ to be

$${X}_{i} = \frac{{S}_{i} ( 2182 nm ) - {S}_{i} ( 2134 nm )}{{S}_{i} ( 2183 nm ) - {S}_{i} ( 2260 nm )}$$

where S₁(WLnm) is log(1/R) for the i-th spectrum at wavelength WL in nanometers. This feature makes use of 4 of the 1011 pieces of spectral data, and may be considered an approximate ratio of derivatives. Least squares provides a linear model AX₁+B yielding a prediction Ŷᵢ of Y₁ An estimate of the average percentage regression error is given by:

$$\frac{100}{N} {\sum }_{i = 1}^{N} \frac{\vert {\hat{Y}}_{i} - {Y}_{i} \vert}{\vert {Y}_{i} \vert}$$

with N being the number of sample spectra in the given data set (N is 50 for the calibration set). Retaining the same notation as for the calibration set, one can compute the feature X₁ for each validation spectrum S₁ and use the above model to predict Y₁ for the validation spectra. The average percentage regression error on the validation set is 0.62%, and this serves as the measure of success for the model. This model is known to be state-of-the-art in terms of both concept and performance for this data, and will be used as point of comparison.

The wavelength-by-wavelength data of each spectrum is a presentation of the data in a particular coordinate system. Walsh packet analysis provides a wealth of alternative coordinate systems in which to view the data. In such a coordinate system, the coordinates of an individual spectrum would be the correlation of the spectrum with a given Walsh packet. The Walsh packets themselves are functions taking on the values 1, −1, and 0 in particular patterns, providing a square-wave analogue of local sine and cosine expansions. Examples of Walsh packets are shown in FIG. 28.

In accordance with the present invention, such functions may be grouped together to form independent coordinate systems in different ways. In particular, the Walsh packet construction is dyadic in nature and yields functions having N=2^{k} sample values. For N=1024, the closest value of N for the example case of spectra having 1011 sample values, the number of different coordinate systems is approximately 10²⁷². If each individual Walsh packet is assigned a numeric cost (with some restrictions), a fast search algorithm exists, which will find the coordinate system of minimal (summed) cost out of all possible Walsh coordinate systems. Despite the large range for the search, the algorithm is in not approximate, and provides a powerful tool for finding representations adapted to specific tasks.

These ideas may be applied to the case of regression for the wheat data in question. Any Walsh packet provides a feature, not unlike the X₁ computed above, simply by correlating the Walsh packet with each of the spectra. These correlations may be used to perform a linear regression to predict the protein concentration. The regression error can be used as a measure of the cost of the Walsh packet. A good coordinate system for performing regression is then one in which the cost, i.e. the regression error, is minimal. The fast algorithm mentioned above gives us the optimal such representation, and a regression model can be developed out of the best K (by cost) of the coordinates selected.

In a particular embodiment, for each of the calibration spectra S₁, first compute all possible Walsh packet features and then determine the linear regression error in predicting the Yᵢ for each Walsh packet. Using this error as a cost measure, select a coordinate system optimized for regression, to provide a (sorted) set of features {X₁(1), . . . , X₁(K)} associated with each spectrum S₁. These features are coordinates used to represent the original data, in the same way that the wavelength data itself does. Four features were used in the standard model described above, and, hence, one can choose K=4 and use partial least squares regression to build a model for predicting Y₁. The average percentage regression error of this model on the validation data set is 0.7%, and this decreases to 0.6% for K=10. FIG. 41A shows a typical wheat spectrum together with one of the top 4 Walsh packets used in this model. The feature that is input to the regression model is the correlation of the Walsh packet with the wheat spectrum. (In this case the Walsh feature computes a second derivative, which suppresses the background and detects the curvature of the hidden protein spectrum in this region).

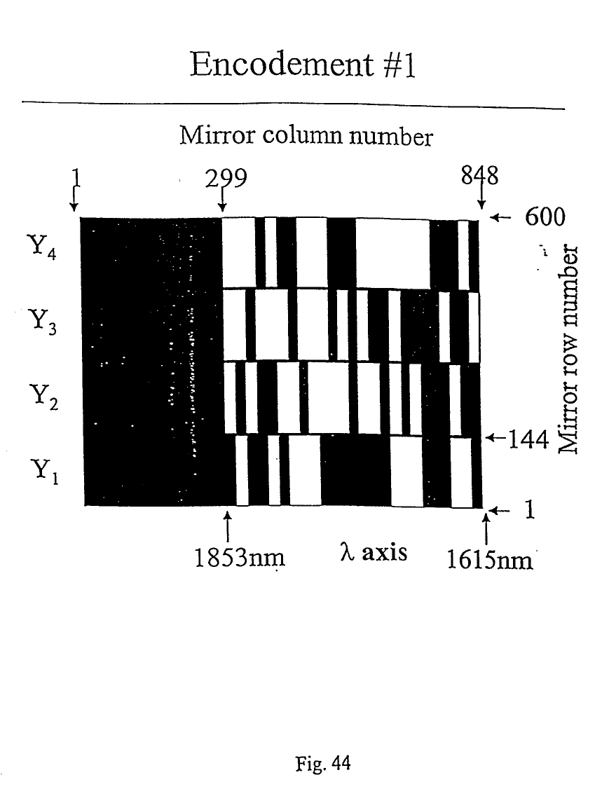

Similar performance is achieved by Walsh packet analysis using the same number of features. The benefit of using the latter becomes clear if noise is taken into account. Consider the following simple and natural experiment: add small amounts of Gaussian white noise to the spectra and repeat the calibrations done above using both the standard model and the Walsh packet model. The results of this experiment are shown in FIG. 43A, which plots the regression error versus the percentage noise energy for both models (we show both the K=4 and the K=10 model for the Walsh packet case to emphasize their similarity). A very small amount of noise takes the two models from being essentially equivalent to wildly different, with the standard model having more than three times the percentage error as the Walsh packet model. The source of this instability for the standard model is clear. The features used in building the regression model are isolated wavelengths, and the addition of even a small amount of noise will perturb those features significantly. The advantage of the Walsh packet model is clear in FIG. 44. The feature being measured is a sum from many wavelengths, naturally reducing the effect of the noise.

The Walsh packet method described here has other advantages as well. One of the most important is that of automation. The fast search algorithm automatically selects the best Walsh packets for performing the regression. If the data set were changed to, say, blood samples and concentrations of various analytes, the same algorithm would apply off the shelf in determining optimal features. The standard model would need to start from scratch in determining via lengthy experiment which wavelengths were most relevant.

Adaptability is also an important benefit. The optimality of the features chosen is based on a numeric cost function, in this case a linear regression error. However, many cost functions may be used and in each case a representation adapted to an associated task will be chosen. Optimal coordinates may be chosen for classification, compression, clustering, non-linear regression, and other tasks. In each case, automated feature selection chooses a robust set of new coordinates adapted to the job in question.

F. Encoding Digital Information in Materials

In an important aspect, the present invention is directed to methods for embedding, writing, and reading digital information and tags in the spectral profile of ink, paint or other materials, in order to provide the functionality of bar codes, digital tags or labels. In particular, this aspect of the invention enables recording of digital information onto or into physical media with or without the use of printed symbols, by means of causing specific changes in the spectrum of the physical media. In particular, this can be done by selecting materials with pre-determined spectral signature and applying the materials onto the media, mixing it with materials of the media or enabling a pre-determined reaction of materials to the output of a source of spectrum radiation. This approach used in accordance with the present invention results in a digital information being encoded onto or into carrying materials, without the need for extracting the encoded information from the position, arrangement, orientation or shape of various recognizable symbols (such as letters in words) or lines in a bar code. In specific embodiments, the visible color properties of the physical media need not be affected. Importantly, the invention provides direct optical means for encoding and reading codes (digital or other).

The idea of using color or more generally spectral bands to discriminate and identify objects is known, for example in the color coding of wires, pills, signs, as well as in the tags used in gene arrays, and in tags, inks and toners used for detection, authentication or security, as in U.S. Pat. Nos. 4,359,633, 5,770,299, 5,861,618, 6,274,323 and 6,354,591, the contents of which is incorporated herein by reference. By contrast, in this aspect the invention relies on the use of quantitative relations between spectral features for digital encoding of information on material surfaces. This feature of the invention enables information storage or imprinting, which do not require symbols or printing—the binary information is derived from direct measurement of spectral features on the material.

The current state of the art in imprinting information on material objects involves printing of symbols or some spatial distribution of material(s) using a limited or single spectral profile, such as written text or bar codes both single color (single spectral signature), and multicolor (multiple spectral signatures). This includes colors or spectral signatures found outside of the visible spectral region, and in general requires a suitable surface, on which printing can be performed. State of the art non-contact marking/printing reading of spatial symbols is done by burning or etching the surface with a high-powered laser using complex beam steering optics. Generally, in the prior art accurate automatic machine scanning of printed characters or codes is only possible when the presence of such symbols has been detected and the symbols positioned for machine reading. By contrast, the approach used in this invention does not require contact or critical positioning of the substrate during encoding, nor during reading.

Other methods currently in use to achieve digital tags use encoded radio frequency activated microchips, which have to be attached to objects and therefore are cumbersome to apply and to handle.

In accordance with this invention, methods are disclosed for encoding and decoding/reading digital information in the properties of materials including the steps of varying the constituents included in a bulk material or by varying the ratios or amounts of the constituents that make up the material. In specific embodiments these changes may be otherwise imperceptible, which is preferable for example where the appearance of the material is important, or where the visible presence of encoded information is not desirable. The constituents, amounts and ratios are selected to store or encode digital information that can be measured or decoded by interacting electromagnetically with the materials to measure the properties of the mixture and decode the digital information

Accordingly, this section of the application discloses methods and apparatuses for encoding, decoding and reading digital information in the distribution, shape and magnitude of spectral absorption bands, intensity of spectral emissions, Raman signals, diffraction products, refractive index variations and/or fluorescence lifetimes of materials.

In accordance with a preferred embodiment, the present invention provides for embedding or laying, layering of information directly onto the surface of an object or substrate by spraying a possibly transparent, spectrally encoded mixture, or by mixing such material in paint, ink, glue or other transport media. Additionally provided are simple direct optical scanning means for reading the embedded information. Unlike the prior art, where a characteristic property of printed symbols is that the location, arrangement and shape of the ink marks contains (at least in part) the encoded information, the proposed approach is largely independent of location, arrangement and shape. Thus, each spot on a surface carries its own information, and individual spots can be randomly distributed, thereby obviating the need to read or decode the provided information in a location-specific manner.

In a preferred embodiment, digital encoding is achieved by precise mixing of a number of possibly inert or transparent materials having characteristic spectral signatures (absorption spectra or fluorescence) preferably in the near infrared wavelength, or more generally, outside the visible spectrum. One example of a pair of such materials are polyethylene and polystyrene, which are used in a preferred embodiment because the differences in their spectra occur in the near infrared wavelength range, and can be detected by inexpensive detectors. In general, each transparent inert material has a unique spectrum, and could be used provided that the differences in spectrum are measurable within the wavelength range of the reader employed in the system. Examples of non-visible materials with characteristic spectral features are given in U.S. Pat. Nos. 4,359,633; 5,861,618, and 6,354,591, which are incorporated herein by reference. In accordance with the present invention, the ratio of concentrations of these materials, when measured and quantized, provides a sequence of numbers, whose binary expansion is used to extract the desired encoded information. The materials mixed in this manner can then be used to encode and imprint or store digital information on or in another material by spraying, painting, mixing, and other suitable processes, resulting in encoding marks.

In accordance with the present invention, information units (such as symbols, words, or others) can be encoded and stored in these marks, preferably one unit per mark. Each such information unit would in a preferred encoding scheme represent one value from a finite set of values, which without loss of generality could be designated as numerical values. In a preferred embodiment, the range of all possible values (or vector of values as in a spectral signature) can be quantized into a set of acceptable values, each having pre-determined meaning within the encoding algorithm. Dependent on the error tolerance for a specific application, the number of acceptable quantization values and thus the ease with which they can be separated can be adjusted. This approach provides error tolerance. Reading and decoding of the information stored in this manner is done in a preferred embodiment using chemometrics to measure relative concentrations of information-carrying components in a compound or mixture, via mathematical analysis of spectral data, and can be used to recover the digital information by reading and processing the spectrum of the encoded marks and quantizing the results.

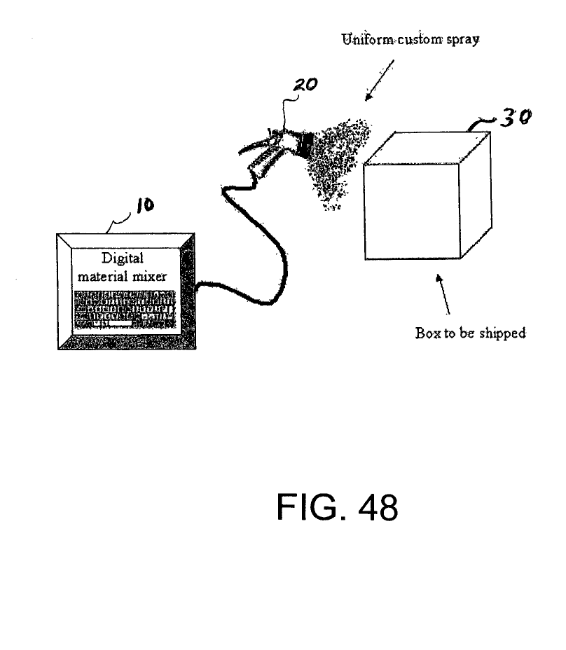

FIG. 48 illustrates a system for topological application of information in accordance with one embodiment of the present invention. In particular, a digital material mixer 10, generally under computer control, mixes predetermined substances, sending the mix to a sprayer 20, to be applied to an object 30 for encoding information on the surface of the object. A simple device that can be used in accordance with one embodiment of the present invention for accurate mixing with digital controls is the head of an inkjet color printer, which is designed to provide a precise digitally controlled mix of color inks.

In accordance with this illustrative embodiment, applying of the encoded mix of materials to a material is done using inkjet printer technology. In particular, this embodiment uses a printer and the inks as they are available off the shelf, to encode digital information. In a preferred embodiment, the process of encoding is accomplished as follows. Start with a sequence of numbers X1, X2, . . ., XN and Y1, Y2, . . ., YN. For simplicity, assume that each number is between 0 and 255. These sequences of numbers are the data to be encoded. Next, print a collection of dots, D1, D2, . . ., DN, so that, for example, the cyan content of Di is Xi, the magenta content of Di is Yi, and the yellow content of Di is i. As noted, the dots are printed randomly, but because of the way in which information is encoded, the data can be read back by, e.g., an ordinary color camera with software capable of computing CYM components from the recorded RGB values. The computation of various color coordinates from recorded RGB values is well known in the art and will not be considered in further detail. The Xi and Yi values are extracted as, respectively, the cyan and magenta components of the dot with yellow content i. Of course, this is a merely illustrative embodiment, and many variants are possible and will be apparent to a person of skill in the art. Thus, for example, an obvious modification is to insert invisible inks into the cartridges instead of, or in addition to, the visible inks described above.

In a preferred embodiment, one can use the inkjet head as a dispensing device to mix ingredients prior to spraying dots on a surface, or in alternative embodiments to spray some geometric combination of dots, bull's-eyes or other patterns that can be recognized and processed with some flexibility independent of orientation and surface roughness characteristics. In different embodiments, various ingredients can be mixed in encoded form to be read by the chemometric devices described above. It will also be appreciated that in general any device capable of storing a plurality of materials and mixing these materials in a controlled way could be used in alternate embodiments to implement the present invention.

In different practical applications it is desirable to encode digital information on many different types of materials and objects. Since these objects can have a wide range of spectral profiles, and these spectral profiles could interfere with the later reading of the encoded information, in a preferred embodiment it is desirable to have a means for encoding of information that takes the spectral signature of the background into account. In a preferred embodiment, this can be accomplished by leaving a portion of a uniform background un-tagged, and thus allowing the reading device to read this background and factor away its absorbance spectrum. Another technique that can be used in accordance with this invention involves adjusting the mixture of the applied tag to compensate for the background spectrum. To this end, a preferred embodiment also includes a spectral reading apparatus, such as one disclosed above and in the previously referenced patents, and used in a feedback loop with the mixing or deposition means, in order to measure the response after a partial deposition or mix has been made, and to adjust the deposition or mixing to create the desired reading response.

By mixing ingredients in the manner disclosed above, one can control the spectral profile of the material so that certain spectral features, such as combined ratio of well-chosen absorption measurements, would provide a number in a string of an encoded digital message. As an example, one could use a mix of concentration of encoding materials, where the ratios of concentrations are the digital information, and the spectral features are precisely the features used to regress these concentrations from spectra as described above. Another approach in accordance with this invention is to use a mix of fluorescent compounds, which when activated would give a spectral profile enabling a quantified reading.

Yet another approach that can be used in accordance with this invention is to selectively react a mixture of chemical constituents, so as to enable spectral encoding by controlling the reaction product(s) and or concentration of same using photochemical methods. This could be accomplished, for example, using chemical or photo bleaching, as well as catalytic interaction, as occurs in the mixture of two epoxies. It should be appreciated that in the latter case the encoder device would consist of a spectrally tunable light source, and that the same device could therefore act as both the encoder device and the reader device.

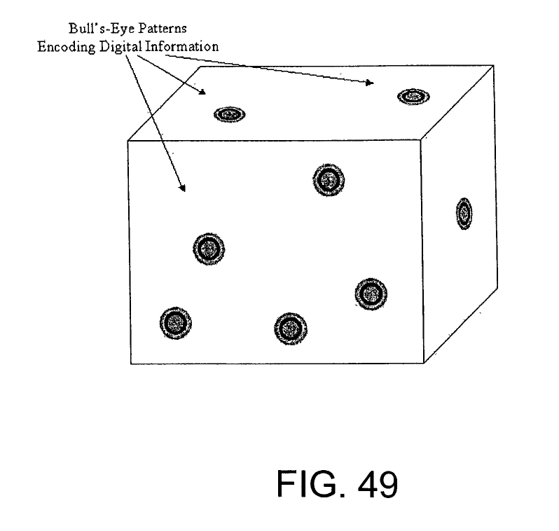

In one preferred embodiment of the invention, a series of concentric rings of coded ink or paint can be sprayed onto an object or surface, in a bull's-eye shape, as shown in FIG. 49. This provides a layout that is readable from all directions in an invariant way, and could be read even in the presence of substantial distortion. It should be noted that this could be implemented by creating a series of concentric tubes, each with its own ink container and pump, to enable the spraying of these bull's eye patterns without the need for direct contact with the target surface. In this embodiment, each tube will carry an information unit, consisting of an encoded mixture of ingredients. This type of geometric localization of spots enables long messages, in which each spot is a word with an order label permitting the formation of a message. The “Bull's eye spot” described here provides an example of this in which each concentric circle is formed by a specific mix to have a digital letter, the center circle, for example, could give the word label, the first ring is could be the first digit, the second ring the second digit, etc.

Note that the idea of using circular marks in barcode and similar systems is known in the prior art. See, for example, U.S. Pat. No. 2,612,994, U.S. Pat. No. 5,869,828 and DE19846961. In the prior art, however, the marks need to be printed in the sense that details of ring spacing and thickness encode the content. By contrast, in accordance with the present invention, these rigid geometric features are essentially irrelevant, allowing for substantial distortions of the shape and layout of the mark, since the information is contained not in the shape of the form but in the spectrum of the mark elements, and only relies on the topological concentric nature of their layout. In one detail of this embodiment, it should be considered that adjacent rings might be blurred together, and therefore it is preferred to alternate between two different sets of materials or ink mixtures, so that these distinct regions could be distinguished on reading, even if the underlying digital information is identical, or in the case where there is severe distortion and the rings overlap substantially. This allows the system designer to adjust system performance parameters in a tradeoff between storage bandwidth, and the robustness of the system to geometric distortion.

It should be appreciated that many variations of the basic idea underlying this invention are possible. A fundamental advantage of such embodiments is that rigid rules concerning shape, position and spatial distribution of geometric features (such as a barcode) can be replaced by topological or weak geometric constraints, since the information is primarily carried in the spectrum of the mark elements. Accordingly, in this application the term “topological application” is used to refer to any application, in which a mark, substance or material is applied to or mixed with another object substance or material in order to convey information, in such way that the precise shape, position, orientation and placement of the mark with respect to the object, or other marks is not needed to recover the encoded information.

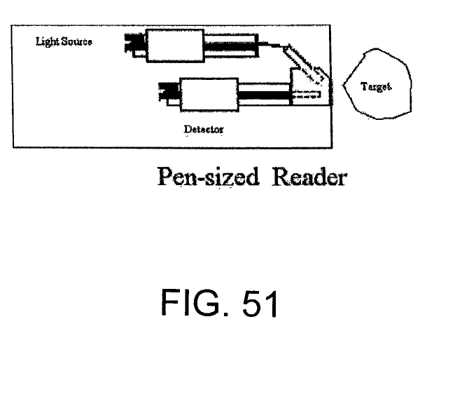

In a preferred embodiment, a device for reading the encoded information consists of a photo-detector, such as a photo-diode, CCD camera, InGaAs detector, or other detector depending on the wavelength ranges of interest, together with a modulatable tunable light source as previously disclosed, such as an LED array or a DMA tunable light source, to illuminate the material with specific well chosen bands, in order to measure directly concentrations of ingredients in the mix. A system for reading digitally encoded data according to the present invention, from a single material encoding digital information could use a single detector, as described. In one embodiment, a reader is illustrated in FIG. 51, which depicts a compact reader apparatus in which a spectrally modulatable light source and a detector are contained in a reading “wand” that can be waived across a mark to read its spectral content. In more complex settings in which multiple “words” of data have been stored, an imaging array or DMA imaging system as previously disclosed can be used.

Well-tuned laser light sources are possible and may be desirable to enable remote scanning in accordance with a specific embodiment. Other direct ways of measuring concentrations can be implemented as ordinary color scanners, by measuring specific absorption of radiation in prescribed bands, the material can be encoded so as to provide a direct digital readout by the scanning equipment.

These measurements of spectrometric quantities embedded on the surface of an object are read directly and can be decoded by reversing the method prescribed by the encoding mixer. Other methods for generating specific optical or spectral responses could involve specially designed dyes as used in photodiodes, and light emitting diodes, in which the spectral signature could be modified by changing the configuration of band gaps. The tags or digital information are encoded in the spectral response signature of the material.

Since the number of ingredients used to encode digital information in general is limited, in different applications it may be desirable to increase the digital information content. This can be achieved in accordance with another embodiment of the invention by placing different messages at different locations say, on a document or surface.

On the other hand, if printing is not desirable and one wishes to encode information in a non-geometric random way, in accordance with this invention it is enough to pepper the surface with non overlapping dots, where each dot contains in its information, a label number as well as a message, the collection of dots is scanned and the messages ordered by label. It will be appreciated that this dot cloud can then be read in any configuration.

A variation of this approach applies when printing is not desired or possible, but something intermediate is acceptable. For example, in this variation, each dot may be encoded with a message and a “local label”. The collection of dots is then scanned and clustered by position, but not ordered within the clusters. Finally, the labels are used simply to order within the cluster. This variation minimizes the number of bits needed to encode symbol ordering, exploiting non-exact information about symbol location, and using just a few bits to correct the non-exact information.

As an example, suppose that a rough surface has locally uneven shape or geometry, and for this reason the ordering of dots sprayed on the surface can change, depending on the angle of view. By mathematical techniques, explicit bounds can be found that describe to what extent such mixing is possible. Then, labels need to only contain enough information to undo this mixing.

Consider, for example, an egg-crate like surface. Viewed from straight above, one sees, for example, the following geometry:

E [F] G [H]

[A] B [C] D

(where “[ ]” means that the point is elevated. This can't be seen from the top necessarily, but is needed to understand the next image). Viewed from another angle, (rotate “[F]” down and into the page, and “[A]” up and out of the page), one might see the following:

E X3 G X4

[A] [F] [C] [H]

X1 B X2 D

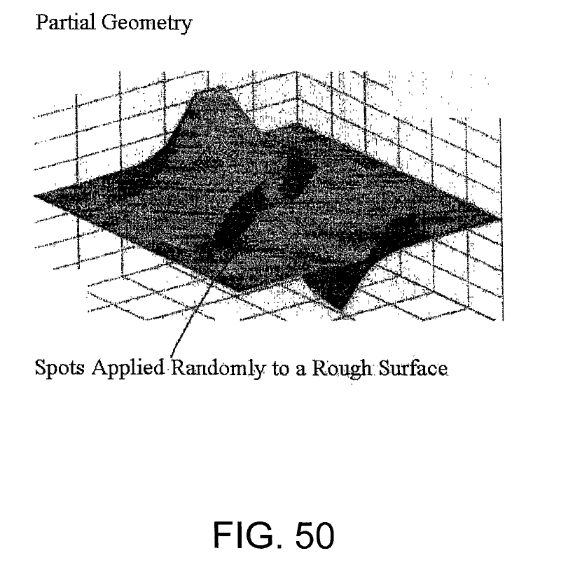

In this instance, two bits (a row parity and a column parity) should be enough to uniquely locate the points with respect to one another, when viewed from any angle that sees all of the points. FIG. 50 illustrates the ambiguity about the relative placement of marks created by viewing a rough or variegated surface from different angles. Numbering the marks using encoded spectra resolves such ambiguities and enables proper ordering of the marks irrespective of the viewing angle.

Another way to label the dots when using concentration ratios, described above involves controlling the concentration of one distinguished element in a mixture, the reference concentration, so that each word has a different reference concentration in increasing order. In this way, one can have as many words as there are levels of reference concentration.

A method for labeling words in a mixed paint environment is to embed different words in different colors or ink cartridges. In this environment one can afford to encode digital data using many more ingredients to obtain more encoded digits.

Still another approach in accordance with this invention is to spray or stamp fix patterns to contain different messages, say triangles of the same or different size, squares, rectangles, bar codes, flowers (for which each petal could be a different word and the stem is a point of reference and flower label), etc.

The present invention enables stamping or spraying of information, visibly and/or invisibly, in situations where bar coding or other printing is undesirable, problematic, or more expensive, and subsequent “reading” of information is difficult or expensive, including but not limited to packages, machine parts and components, pill coatings, car body paint, mail, documents.

In another aspect, the present invention enables identification and authentication marks. For example, one could provide an ink cartridge containing digitally encoded ink according to the present invention, to each unique user, computer, printer or meter. In this way, each printing event, or metering event, such as value metering (e.g., transmission by a provider of virtual cash or postage), could be identified by a spectral identification number. This enables authentication and tracing of original documents (as opposed to photocopies), as well as generally tracking and communicating information about the source or history of a printed mark. Such documents could include, but not be limited to, valuable papers, money, stock certificates, passports, tickets and credit cards. A digital message can be encoded on a document by invisible coloring of different regions on a surface, each region being imprinted with a different encoded mix.

The present invention further can be used to augment existing means of marking, as described, for example, in the previous two paragraphs. It can also be used to place marks, hidden or otherwise, on or in objects or materials, for novel uses such as tracking and tracing.

IV. Applications

A number of applications of approaches and techniques used in accordance with the present invention were discussed or pointed to in the above disclosure. In this Section we present two practical applications illustrative of the invention.

A. Gray Level Camera Processing System and Method

A system in which a video camera is synchronized to the tunable light source modulation allowing analysis of the encoded spectral bands from a plurality of video images, thereby providing a multispectral image. Since the ambient light is not modulated it can be separated from the desired spectral information. This system is the functional equivalent of imaging the scene a number of times with a multiplicity of color filters. It allows the formation of any virtual photographic color filter with any absorption spectrum desired. A composite image combining any of these spectral bands can be formed to achieve a variety of image analysis, filtering and enhancing effects.

For example, an object with characteristic spectral signature can be highlighted by building a virtual filter transparent to this signature and not to others (which should be suppressed). In particular, for seeing the concentration of protein in a wheat grain pile (the example discussed below) it would be enough to illuminate with two different combination of bands in sequence and take the difference of the two consecutive images. More elaborate encodements may be necessary if more spectral combinations must be measured independently, but the general principle remains.

In a different embodiment, an ordinary video camera used in accordance with this invention is equipped with a synchronized tunable light source so that odd fields are illuminated with a spectral signature which is modulated from odd field to odd field while the even fields are modulated with the complementary spectral signature so that the combined even odd light is white. Such an illumination system allows ordinary video imaging which after digital demodulation provides detailed spectral information on the scene with the same capabilities as the gray level camera.

This illumination processing system can be used for machine vision for tracking objects and anywhere that specific real time spectral information is useful

In another embodiment, a gray level camera can measure several preselected light bands using, for example, 16 bands by illuminating the scene consecutively by the 16 bands and measuring one band at a time. A better result in accordance with this invention can be obtained by selecting 16 modulations, one for each band, and illuminating simultaneously the scene with all 6 colors. The sequence of 16 frames can be used to demultiplex the images. The advantages of multiplexing will be appreciated by those of skill in the art, and include: better signal to noise ratio, elimination of ambient light interference, tunability to sensor dynamic range constraints, etc.

A straightforward extension of this idea is the use of this approach for multiplexing a low resolution sensor array to obtain better image quality. For example, a 4×4 array of mirrors with Hadamard coding could distribute a scene of 400×400 pixels on a CCD array of 100×100 pixels resulting in an effective array with 16 times the number of CCD. Further, the error could be reduced by a factor of four over a raster scan of 16 scenes.

B. Chemical Composition Measurements

In accordance with the present invention by irradiating a sample of material with well-chosen bands of radiation that are separately identifiable using modulation, one can directly measure constituents in the material of interest. This measurement, for example, could be of the protein quantity in a wheat pile, different chemical compounds in human blood, or others. It should be apparent that there is no real limitation on the type of measurements that can be performed, although the sensors, detectors and other specific components of the device, or its spectrum range may differ.

In the following example we illustrate the measurement of protein in wheat, also discussed in Section III.E. above. The data consists of two groups of wheat spectra, a calibration set with 50 samples and a validation set of 54 samples.

With further reference to Section III.B, FIG. 39 shows a DMA search by splitting the scene. The detection is achieved by combining all photons from the scene into a single detector, then splitting the scene in parts to achieve good localization. In this example, one is looking for a signal with energy in the red and blue bands. Spectrometer with two detectors, as shown in FIG. 27 can be used, so that the blue light goes to the top region of the DMA, while the red goes to the bottom.

First, the algorithm checks if it is present in the whole scene by collecting all photons into the spectrometer, which looks for the presence of the spectral energies. Once the particular spectrum band is detected, the scene is split into four quarters and each is analyzed for presence of target. The procedure continues until the target is detected.

FIG. 40 illustrates the sum of wheat spectra training data (top) Sum of |w| for top 10 wavelet packets (middle) and an example of protein spectra—soy protein (bottom). The goal is to estimate the amount of protein present in wheat. The middle portion of the figure shows the region where the Walsh packets provide useful parameters for chemo-metric estimation

FIG. 41 illustrates the top 10 wavelet packets in local regression basis selected using 50 training samples. Each Walsh packet provides a measurement useful for estimation. For example, the top line indicates that by combining the two narrow bands at the ends and the subtracting the middle band we get a quantity which is linearly related to the protein concentration. FIG. 42 is a scatter plot of protein content (test data) vs. correlation with top wavelet packet. This illustrates a simple mechanism to directly measure relative concentration of desired ingredients of a mixture.

It will be appreciated that in this case one could use an LED-based flashlight illuminating in the three bands with a modulated light, which is then imaged with a CCD video camera that converts any group of consecutive three images into an image of protein concentration. Another implementation is to replace the RGB filters on a video camera by three filters corresponding to the protein bands, to be displayed after substraction as false RGB. Various other alternative exist and will be appreciated by those of skill in the art.

FIG. 43 illustrates PLS regression of protein content of test data: using top 10 wavelet packets (in green—1.87% error, from 6 LVs) and top 100 (in red—1.54% error from 2 LVs)—compare with error of 1.62% from 14 LVs using all original data. This graph compares the performance of the simple method described above to the true concentration values.

FIG. 44 illustrates the advantage of DNA-based Hadamard Spectroscopy in terms of visible improvement in the SNR of the signal for the Hadamard Encoding over the regular raster scan.

It will be appreciated that the above approach can be generalized to a method of detecting a chemical compound with known absorption lines. In particular, a simple detection mechanism for compounds with known absorption is to use an active illumination system that transmits light (radiation) only in areas of the absorption spectrum of the compound. The resulting reflected light will be weakest where the compound is present, resulting in dark shadows in the image (after processing away ambient light by, for example, subtracting the image before illumination). Clearly, this approach can be used to dynamically track objects in a video scene. For example, a red ball could be tracked in a video sequence having many other red objects, simply by characterizing the red signature of the ball, and tuning the illumination to it, or by processing the refined color discrimination. Clearly this capability is useful for interactive TV or video-gaming, machine vision, medical diagnostics, or other related applications. Naturally, similar processing can be applied in the infrared range (or UV) to be combined with infrared cameras to obtain a broad variety of color night vision or (heat vision), tuned to specific imaging tasks. To encode the received spatial radiation components one can use pulse code modulation (PCM), pulse width modulation (PWM), time division multiplexing (TDM) and any other modulation technique that has the property of identifying specific elements of a complex signal or image.

In accordance with the invention, in particular applications one can rapidly switch between the tuned light and its complement, arranging that the difference will display the analate of interest with the highest contrast. In addition, it is noted that the analate of interest will flicker, enabling detection by the eye. Applications of this approach in cancer detection in vivo, on operating table, can easily be foreseen.

C. Encoding Information in Physical Matter

Another straightforward extension of the present invention is method for initiating select chemical reactions using a tunable light source. In accordance with this aspect, the tunable light source of this invention can be tuned to the absorption profile of a compound that is activated by absorbing energy, to achieve curing, drying, heating, cooking of specific compounds in a mixture. Applications further include photodynamic therapy, such as used in jaundice treatment, chemotherapy, and others.

Yet another application is a method for conducting spectroscopy with determining the contribution of individual radiation components from multiplexed measurements of encoded spatio-spectral components. In particular a multiplicity of coded light in the UV band could be used to cause fluorescence of biological materials, the fluorescent effect can be analyzed to relate to the specific coded UV frequency allowing a multiplicity of measurements to occur in a multiplexed form. An illumination spectrum can be designed to dynamically stimulate the material to produce a detectable characteristic signature, including fluorescence effects and multiple fluorescent effects, as well a Raman and polarization effects. Shining UV light in various selected wavelengths is known to provoke characteristic fluorescence, which when spectrally analyzed can be used to discriminate between various categories of living or dead cells.

Another important application of the system and method of this invention is the use of the OSPU as a correlator or mask in an optical computation device. For example, an SLM, such as DMA can act as a spatial filter or mask placed at the focal length of a lens or set of lenses. As illustrated above, the SLM can be configured to reject specific spatial resolution elements, so that the subsequent image has properties that are consistent with the spatial filtering in Fourier space. It will be apparent that the transform of the image by optical means is spatially effected, and that the spatial resolution of images produced in this manner can be altered in any desired way.

Yet another area of use is performing certain signal processing functions in analog domain. For example, spatial processing with a DMA can be achieved directly in order to acquire various combinations of spatial patterns. Thus, an array of mirrors can be arranged to have all mirrors of the center of the image point to one detector, while all the periphery goes to the other. Another useful arrangement designed to detect vertical edges will raster scan a group of, for example, 2×2 mirrors pointing left combined with an adjacent group of 2×2 mirrors pointing right. This corresponds to a convolution of the image with an edge detector. The ability to design filters made out of patterns of 0, 1, −1 i.e., mirror configurations, will enable the imaging device to only measure those features which are most useful for display, discrimination or identification of spatial patterns.

The design of filters can be done empirically by using the automatic best basis algorithms for discrimination, discussed above, which is achieved by collecting data for a class of objects needing detection, and processing all filters in the Walsh Hadamard Library of wavelet packets for optimal discrimination value. The offline default filters can then be upgraded online in realtime to adapt to filed conditions and local clutter and interferences.

Additional applications of the system and method for encoding information into physical matter, as discussed in Section F above include stamping (spraying) information, visibly and/or invisibly, in situations where bar coding or other printing is undesirable, problematic, or more expensive, and subsequent “reading” of information is difficult or expensive. Examples of applications include handling of packages, machine parts and components, pill coatings, car body paint, mail, documents, etc.

In addition the methods f encoding information in this application can be used for identification and authentication purposes. For example, an ink cartridge, each unique user, each computer, and/or each “value metering” event (e.g., transmission by a provider of virtual cash or postage) could be identified by a spectral identification numbers to enable authentication and tracing of original documents (as opposed to photocopies). These documents could be valuable papers, money, stock certificates, passports, credit cards etc. A digital message can be encoded on a document by invisible “coloring” of different regions on a surface, each region being imprinted with a different encoded mix

While the foregoing has described and illustrated aspects of various embodiments of the present invention, those skilled in the art will recognize that alternative components and techniques, and/or combinations and permutations of the described components and techniques, can be substituted for, or added to, the embodiments described herein. It is intended, therefore, that the present invention not be defined by the specific embodiments described herein, but rather by the appended claims, which are intended to be construed in accordance with the well-settled principles of claim construction, including that: each claim should be given its broadest reasonable interpretation consistent with the specification.

We claim:

1. A method for encoding information, comprising the steps of:
providing two or more materials capable of reacting predictably to one or more radiation components in a given spectral range;
selecting a combination of the two or more materials, the selected combination having a spectral response signature in the given spectral range corresponding to one of a plurality of distinct numerical values associated with a predetermined encoding algorithm; and
applying the combination of materials to an object in one or more marks, the specific position, arrangement, orientation and shape of a mark with respect to the object or to other marks not being part of the encoding algorithm.

2. The method of claim 1, wherein the combination of the two or more materials is a mixture.

3. The method of claim 1, wherein the combination of the two or more materials causes a chemical reaction.

4. The method of claim 1, wherein the combination of the two or more materials causes catalytic interaction.

5. The method of claim 1, wherein the predetermined spectral range is in the near infrared spectrum.

6. The method of claim 1, wherein the predetermined spectral range is in a range comprising one or more of: UV, visible, near infrared, infrared, microwave.

7. The method of claim 1, wherein the spectral response signature consists of one or more of the absorption spectra, fluorescence spectra, or Raman spectra.

8. The method of claim 1, wherein the two or more materials comprise polyethylene and polystyrene.

9. The method of claim 1, wherein the step of applying comprises the step of embedding the selected combination of materials through mixing with or depositing within at least one physical object.

10. The method of claim 1, wherein the step of applying is carried out on a limited portion of the external surface of the object.

11. The method of claim 1, wherein a plurality of applied marks encode a message defined as an ordered sequence of values, and the sequence of values in the message is encoded in one or more of: the spectral signature of each mark and the topology of the pattern in which marks are applied.

12. The method of claim 1 further comprising the step of irradiating the physical object with radiation components in the predetermined spectrum range.

13. The method of claim 12 further comprising the step of measuring the interaction of the selected combination of materials with the irradiating components.

14. The method of claim 13 further comprising the step of decoding information corresponding to the uniquely identifiable spectrometric signature.

15. The method of claim 13, wherein the step of measuring is performed using optical spectrometric means.

16. The method of claim 2, wherein information is encoded in the ratios of material concentrations selected in the combination.

17. The method of claim 16, wherein the ratios are measured using methods of chemometric spectroscopy.

18. The method of claim 12, wherein the step of irradiating is performed using a fixed set of radiation components.

19. The method of claim 18, wherein irradiating the object using the fixed set of radiation components causes a visible response.

20. The method of claim 1, wherein two or more combinations are selected in the step of selecting, to encode two or more corresponding information units at distinct locations or strata, in or on the surface of the object.

21. The method of claim 1, wherein the combination of materials is in a liquid ink form and contained in an ink cartridge.

22. The method of claim 1, wherein the physical object is one or more of: a pill, a drug, product coating, product enclosure, and a document.

23. The method of claim 22, wherein the selected combination encodes one or more of: identity, origin, environmental exposure history, shelf time, lot number, object constituents, routing instructions, assembly instructions, digital data file for machine reading, watermarking, bar code functionality.

24. The method of claim 11 further comprising the step of decoding messages based on the spectrometric signature of marks and information concerning the ordered sequencing of values corresponding to the marks.

25. A system for encoding information, comprising:
two or more materials capable of reacting predictably to one or more radiation components in a given spectral range;
a selector for selecting a combination of the two or more materials, the selected combination having a spectral response signature in the given spectral range corresponding to one of a plurality of distinct values associated with a predetermined encoding algorithm; and
an applicator for applying the combination of materials to an object in one or more marks, the specific position, arrangement, orientation and shape of a mark with respect to the object or to other marks not being part of the encoding algorithm.

26. The system of claim 25 further comprising a decoder for reading information encoded in marks applied to an object.

27. The system of claim 25, wherein the applicator comprises an ink jet printer head.

28. A method for encoding information on a surface of an object, comprising:
applying at random locations on the surface of the object of marks, each mark having a label indicating position in an ordered sequence and a word, encoded solely in the spectrometric signature of the mark.

29. The method of claim 28, further comprising the step of reading information encoded on the surface of the object as a message, whose words are ordered by the labels of each mark.

30. The method of claim 28, further comprising the step of selecting materials to react predictably to one or more radiation components in a predetermined spectral range, the selected combination having a uniquely identifiable spectrometric response signature.

31. A system for encoding digital information, comprising:
(a) a collection of materials for use as inks or dyes, capable of providing selected or tunable spectral signatures;
(b) an encoder, selecting subsets from the collection of materials, a subset corresponding to a unit of coded information;
(c) means for applying the collection of materials onto or in a surface of the object;
(d) a reader capable of determining the spectral signature of materials deposited on or in the surface of the object; and
(e) a processor for determining units of coded information from the output of the reader, the processor not relying on the specific position, arrangement, orientation and shape of collections of applied materials with respect to the object.

32. The system of claim 31 further comprising a tunable light source causing a subset from the collection of materials to react in a predetermined way resulting in a unique spectral signature.

33. The system of claim 31, wherein the reader comprises a spectrometer.

34. A method for encoding information, comprising the steps of:
selecting a combination of the two or more materials, the selected combination having a spectral response signature encoding a plurality of numerical values interpretable in accordance with a predetermined encoding algorithm;
applying the combination of the two or more materials to an object without regard to shape, position or orientation of the application marks.

35. The method of claim 34 further comprising the step of reading the information encoded in the application marks on an object.

36. A method for encoding information, comprising the steps of:
selecting a combination of the two or more materials, the selected combination having a spectral response signature encoding a plurality of numerical values interpretable in accordance with a predetermined encoding algorithm; and
providing topological application of the combination of the two or more material to an object.

37. The method of claim 36, wherein the provided topological application has concentric elements.

38. The method of claim 36, wherein the provided topological application is one of: Bulls eye, flowers.

39. A labeling system, comprising:
(a) a combination of two or more materials capable of reacting predictably to one or more radiation components in a predetermined spectrum range, the combination having uniquely identifiable spectrometric response signature;
(b) means for applying the combination to an object in a plurality of marks forming a label, the application being without regard to the specific position, arrangement, orientation and shape of a mark with respect to the object or to other marks.

40. The system of claim 39, wherein the formed label is invisible to a human observer.

41. The system of claim 39, wherein the predetermined spectrum range is in a range comprising one or more of: UV, visible, near infrared, infrared and microwave.

42. The system of claim 39, wherein the formed label is invisible absent an application of an electromagnetic stimulus in the predetermined spectrum range.

43. The system of claim 39, wherein the means for applying comprises means for selecting one of several combinations of materials, each combination corresponding to one or more objects being labeled.

44. The system of claim 39, wherein the combination of materials is in a liquid ink form and the means for applying comprises an ink cartridge.

45. The system of claim 44, wherein said two or more materials are stored separately and are combined at the time of application to the object.

46. The system of claim 44, wherein the means for applying comprises a printer.

47. The system of claim 44, wherein the means for applying comprises a spray mechanism.

48. The system of claim 39, wherein the object to be labeled is one of: credit card, legal document, bank note, stock certificate, personal identification, pills, prescription medicine, packaging materials.
